(19) United States
(12) Patent Application Publication
(10) Pub. No.: US 2023/0357544 A1
(43) Pub. Date: Nov. 9, 2023

(54) RELEASE FILM HAVING A THIN RELEASE COATING

(71) Applicant: Loparex Germany GmbH & Co. KG, Forchheim (DE)

(72) Inventors: Michael SCHUHMANN, Cadolzburg (DE); Sahin SAYGILI, Forchheim (DE); Werner SCHMIDT, Forchheim (DE); Harald GERLACHER, Memmelsdorf (DE); Josef MÜLLER, Eggolsheim (DE)

(21) Appl. No.: 18/028,693

(22) PCT Filed: Nov. 10, 2021
(86) PCT No.: PCT/EP2021/081296

§ 371 Date: Mar. 27, 2023

(30) Foreign Application Priority Data
Nov. 10, 2020 (DE) 10 2020 214 073.1
Jul. 22, 2021 (DE) 10 2021 119 043.6

(51) Int. Cl. C08L 23/04; C09J 7/40; C09D 183/06

(52) U.S. Cl. CPC C08L 23/04; C09J 7/403; C09D 183/06

(57) ABSTRACT

The invention relates to a method for producing a release film by coating a carrier film using a release coating, wherein the method comprises the steps of: (a) providing the carrier film, wherein the carrier film has a first surface side and a second surface side; wherein the carrier film is preferably structured; (b) providing a coating composition which has a solvent component, preferably comprising ethyl acetate, propyl acetate, butyl acetate, and/or n-propanol, and a silicone system curable by UV radiation; (c) coating at least part of the first surface side of the carrier film provided in step (a) using the coating composition provided in step (b); (d) evaporating at least a part of the solvent component; and (e) irradiating at least part of the first surface side of the carrier film coated in step (c) using UV radiation to cure the silicone system.

The priorities of German patent application No. 10 2020 214073.1 of 10 Nov. 2020 and German patent application No. 10 2021 119043.6 of 22 Jul. 2021 are claimed.

The invention relates to a method for producing a release film by coating a carrier film using a release coating, wherein the method comprises the steps of: (a) providing the carrier film, wherein the carrier film has a first surface side and a second surface side; wherein the carrier film is preferably structured; (b) providing a coating composition which has a solvent component, preferably comprising ethyl acetate, propyl acetate, butyl acetate, and/or n-propanol, and a silicone system curable by UV radiation; (c) coating at least part of the first surface side of the carrier film provided in step (a) using the coating composition provided in step (b); (d) evaporating at least a part of the solvent component; and (e) irradiating at least part of the first surface side of the carrier film coated in step (c) using UV radiation to cure the silicone system.

Release films which are based on carrier films having a release coating are known in numerous embodiments from the prior art. The carrier films can be based on polymers such as polyolefins, nonwovens, and/or paper.

Furthermore, applying the release coatings to the carrier films as coating compositions in the flexographic printing method is known. Suitable coating compositions are used for this purpose, which are usually solvent-free and contain reactive components which are then activated and cured under the action of radiation, in particular UV radiation. Such coating compositions, which are suitable for use in the flexographic printing method, are commercially available.

WO 00/44844 A1 discloses release films and methods for their production. The release films contain at most approximately 1.5 micrograms/square centimeter of unreacted silicone materials (extractable materials). The release films are produced from radiation curable silicone release materials using a solvent coating.

US 2002 009486 A1 relates to a therapeutic agent delivery device which can be applied to a host to therapeutically deliver a therapeutically active agent to the host, wherein the device contains a reflective optical film.

US 2002 176973 A1 discloses laminates including cellulose material, which exhibit dimensional stability when subjected to changes in ambient humidity. The laminates comprise at least two layers which consist of a cellulose material located between an inner polymer layer. The polymer layer is thicker than either of the cellulose layers.

US 2005 214494 A1 relates to a production substrate made of sheet-like products. The substrate comprises a paper layer having a first surface and a second surface, a barrier layer which is formed on the first surface of the paper layer, and a release layer which is formed on the barrier layer.

US 2008 145675 A1 discloses an antistatic surface treatment for plastic films or similar materials, in which an additive that produces the antistatic properties is contained in the surface.

US 2015 284590 A1 relates to a curable organopolysiloxane composition, comprising: (A) at least one type of rubbery or liquid organopolysiloxane having a viscosity of not less than 20 mPa·s, wherein a content of the vinyl (CH₂═CH—)-part of higher alkenyl groups is in the range of 2.0 to 5.0 mass-%; (B) an organopolysiloxane resin formed essentially from R¹₃SiO_{1/2} units and SiO_{4/2} units, wherein the molar ratio of the R¹₃SiO_{1/2} units to the SiO_{4/2} units is 0.5 to 2.0 and the content of vinyl (CH₂═CH—)— part of the alkenyl groups is less than 1.0 mass-%; (C) an organohydrogenpolysiloxane; (D) a hydrosilylation reaction catalyst; and optionally (E) an organic solvent. In such a composition, a mass ratio of component (A) to component (B) is in a range of 2/8 to 8/2.

US 2018 154575 A1 relates to methods, systems, and devices, which relate to the application of a coating to a release liner substrate, comprising directing the coating material onto a release liner substrate material via at least one material dispensing head and release films produced in accordance with the disclosed methods, systems, and devices.

US 2018 311889 A1 discloses a method for treating a substrate having millimeter and/or micron and/or nanometer structures. The method comprises applying at least one protective material to the structures, wherein the at least one protective material can be dissolved in a solvent and the structures are produced by an embossing process.

JP 2019 123853 A relates to a double-sided adhesive film in which one surface of a double-sided adhesive film has strong adhesion to an adhesive surface and the other surface has excellent reworkability, wherein the double-sided adhesive film contains no base film.

However, methods from the prior art for producing release films, which are based on carrier films having a release coating and the release films thus produced are not satisfactory in all respects and there is a need for improved methods and improved release films. According to the prior art, difficulties arise in particular when the carrier films are structured or at least have an uneven surface.

In such cases, up to this point initially largely planar, non-structured carrier films have been coated using the coating compositions in the flexographic printing method and the release films produced in this way have only been structured, for example embossed, in a downstream method step. However, the mechanical action on the release films associated with such a downstream structuring has the disadvantage that the coating composition on the carrier film is affected at the points of particularly high mechanical action. As a result of expansion or compression of the carrier film, defects can form in the release coating or its layer thickness can at least be changed in such a way that a satisfactory release effect cannot always be ensured in these areas. In extreme cases, the release coating is even destroyed in these areas.

Particular difficulties arise when the carrier film is additionally printed, because then the printed image can also be damaged by the mechanical action.

If the carrier films were instead already used in the structured state, for example embossed carrier films, and these structured carrier films were coated using conventional coating compositions in the flexographic printing method, the wetting of the coating composition on the structured or uneven carrier films would sometimes be insufficient and uneven layer thicknesses of the release coating and possibly defects would form along the three-dimensional topography of the surface. A certain degree of unevenness is already present in pure polyolefin films and increases with additives and an additional embossed structure: polyolefin films<additive-enhanced polyolefin films<embossed polyolefin films<embossed, additive-enhanced polyolefin films.

In order to ensure adequate wetting of the structured carrier films using conventional coating compositions, it is possible in principle to increase the temperature and thus reduce the viscosity of the coating compositions. However, the application weights of the coating compositions cannot be reduced arbitrarily, which would be desirable per se, since high application weights are not absolutely necessary for the subsequent release effect, but they do increase the production costs.

A disadvantage of conventional methods for producing release films is in general the comparatively high consumption of the coating compositions, which are comparatively expensive and make these methods uneconomical. Ultimately, the layer thickness of the release coating in the case of the conventionally produced release films is greater, at least in some areas, than it would have to be in order to ensure an adequate release effect. It would therefore be desirable to apply as uniform a release coating as possible having a low layer thickness (i.e., a low basis weight) to the carrier films, for example in the flexographic printing method, wherein structured release films can also be produced without being confronted with the disadvantages of the prior art explained above.

In addition, it would be desirable to coat structured and optionally additionally printed carrier films using coating compositions, wherein the applied release coating covers the surface of the carrier films as evenly as possible, without defects occurring and without the use of material for the coating composition being greater than would be required for the later release effect.

In addition, it would be desirable to use as little material as possible for the coating composition, in addition to the associated cost savings, so that the release films produced in this way can later be better recycled. Recyclability is improved when the amount of coating material is less.

Depending on the application, release films have to have further properties which cannot always be guaranteed in a satisfactory manner using the conventional methods for their production. If the release films are to be used for hygiene articles, odor neutrality and compliance with other regulations are essential.

There is therefore a need for release films and methods for their production, which have advantages over the prior art or overcome the above-mentioned disadvantages.

The object of the invention is to provide advantageous release films and an advantageous method for producing such release films. The release films should enable a good release effect with a comparatively low material requirement. With the aid of the method, it is to be possible to apply a coating composition, preferably based on silicone system curable by UV radiation, to uneven and possibly structured carrier films, with improved and stabilized wetting, preferably using the flexographic printing method. The release coating is to satisfactorily cover the surface of the carrier layer to ensure the desired release properties without requiring excessive material usage.

This object is achieved the subject matter of the claims.

Surprisingly, it has been found that very thin release films having a comparatively small total layer thickness can be provided, which have a correspondingly comparatively thin release coating. Despite the low total layer thickness, the release films have a stable and uniform release coating. As a result, less material is required for the films themselves and for the release coating in comparison to thicker release films. Not only can costs be saved due to the lower use of materials, but the recyclability of the release films is also improved.

Furthermore, it has surprisingly been found that carrier films based on polyolefin are particularly suitable for providing correspondingly thin release films. Compared to other, in particular paper-based carrier films, polyolefin-based carrier films have high tear strength, good temperature resistance, and low water absorption with high chemical stability. It is additionally possible to coat such carrier films using a comparatively thin and stable release coating.

Surprisingly, it has been found that the properties of conventional coating compositions based on silicone system curable by UV radiation can be improved with the aid of suitable solvents or solvent mixtures (solvent components). The use of a solvent component is counterintuitive in that many commercially available coating compositions based on silicone system curable by UV radiation are currently trying to reduce the use of solvents to a minimum. However, according to the invention it has surprisingly been found that it is not necessary at all to dispense with solvents in this way, but rather that disadvantages of conventional methods can be overcome by using suitable solvent components, without giving up the advantages associated with dispensing with the use of solvents at the same time.

Furthermore, it has surprisingly been found that the consumption of coating compositions based on silicone system curable by UV radiation can be significantly reduced by the use of solvent components, without this having a disadvantageous effect on the release properties. Since the solvent component can be easily evaporated, recovered, and recycled, the production costs do not increase significantly; they are ultimately significantly reduced due to the lower consumption of coating composition. The cost savings for the reduced need for coating composition significantly compensates for the slightly higher expense for solvent, evaporation, and recovery.

In addition, it has surprisingly been found that with the aid of suitable solvent components, the wetting of the formulation of the coating composition on the surface of the carrier film to be equipped with release properties, i.e., the surface of the carrier film to which the release coating is to be applied, is improved and stabilized, wherein in particular uneven or even structured carrier foils can also be coated without the disadvantages known from the prior art, for example defects, occurring.

Furthermore, it has surprisingly been found that coating compositions based on silicone system curable by UV radiation can be processed on conventional systems for equipping carrier films with release properties, even with the addition of solvent components. The additional effort with regard to safety precautions such as explosion protection and workplace concentration is low because conventional systems already ensure a maximum level of safety in this regard.

In addition, it has surprisingly been found that when suitable solvents are selected or mixed, it is possible for the solvents to evaporate practically completely during production, so that the release films produced contain at most the smallest residual amounts of solvent. In order to counteract possible odor nuisance caused by such residual amounts, solvents can be used which meet the requirements for problem-free application and drying of the coating composition, but which, in small amounts, are no longer perceived by the human nose.

In particular, it has been found that certain esters are particularly suitable for the method according to the invention, since they unify an optimum of the desired properties in many respects, in particular:
(i) low cost;
(ii) low odor nuisance due to residues;
(iii) low safety risk (explosion protection, flammability, toxicity, etc.);
(iv) good compatibility with UV-curable silicone systems (polarity, dipole moment, dielectric constant, etc.);
(v) improvement and stabilization of the wetting of the coating composition on the optionally structured carrier film (fluidity, viscosity, surface tension, etc.); and
(vi) good volatility and recyclability (boiling point, evaporation number, etc.).

Ethyl acetate, propyl acetate, and butyl acetate have proven to be particularly suitable according to the invention. Within this group, propyl acetate and butyl acetate have the advantage of a higher boiling point in comparison to ethyl acetate, which counteracts (premature) increase in viscosity due to (premature) evaporation; such a viscosity increase would be accompanied by worse and less stable wetting. In addition, more stable mixtures with the other components of the coating composition, in particular with the UV-curable silicone systems, can be produced using propyl acetate and butyl acetate, in particular even if the system is not equipped with an online measuring mixing system for the solvent component. Despite the higher boiling point, these solvents can be easily evaporated, recovered (condensed), and returned to the method (recycled) at the end of the production of the release films with little energy input.

Propanol, in particular n-propanol, has also proven to be particularly suitable according to the invention.

In comparison to other solvents, these solvents (ethyl acetate, propyl acetate, butyl acetate, and n-propanol) for conventional UV-curable silicone systems cause improved adhesion of the coating composition and the resulting release coating on the carrier films, in particular if the surface to be coated is based on polyolefins. The release effect of the release films produced using these solvents is also improved in comparison to release films of identical structure and identical composition, in the production of which other solvents were used. In the small residual amounts, in which these solvents remain at most in the release film, these solvents are also odorless.

Furthermore, these solvents are particularly advantageous for the coating of release films according to the invention, which are based on polyolefin. Polyolefins, in particular polyethylene and polypropylene, have different levels of resistance to various solvents, wherein the resistance to esters such as ethyl acetate, propyl acetate, and butyl acetate is comparatively high.

A first aspect of the invention relates to a release film comprising
(i) a carrier film comprising
   optionally a first sealing layer (a);
   a layer (b), which is based on polyolefin, wherein the polyolefin is selected from the group consisting of olefin homopolymers or copolymers of α,ß-unsaturated olefins having 2 to 10 carbon atoms; and
   optionally a second sealing layer (c); and
(ii) a release coating, which has a basis weight of at most 0.7 g/m²;
wherein the carrier film has a first surface side and a second surface side;
wherein the first surface side of the carrier film is at least partially coated using the release coating; and
wherein the release film has a total layer thickness of at most 25 μm.

In preferred embodiments, the release coating of the release film according to the invention has a basis weight of at most 0.5 g/m²; preferably at most 0.45 g/m²;
wherein the release coating is preferably based on at least one cured polysiloxane; preferably selected from the group consisting of polydialkylsiloxanes, preferably polydimethylsiloxanes; and polyalkylarylsiloxanes, preferably polymethylphenylsiloxanes; preferably chemically crosslinked acrylate-functionalized polysiloxanes; more preferably chemically crosslinked acrylate-functionalized polydialkylsiloxanes, preferably chemically crosslinked acrylate-functionalized polydimethylsiloxanes; or chemically crosslinked acrylate-functionalized polyalkylarylsiloxanes, preferably chemically crosslinked acrylate-functionalized polymethylphenylsiloxanes;
wherein the release coating preferably comprises at least one further cured polysiloxane; preferably an acrylate-functionalized polydialkylsiloxane; preferably a chemically crosslinked long chain acrylate-functionalized polydialkylsiloxane;
where the average release force of the release film is at most 30 cN/cm; preferably at most 25 cN/cm, preferably at most 20 cN/cm, more preferably at most 15 cN/cm, most preferably at most 12 cN/cm, and in particular at most 10 cN/cm; preferably determined according to FINAT 10; where the release force of the release film over multiple measurements has a variance of at most 6.0 cN²/cm²; preferably at most 3.0 cN²/cm², more preferably at most 1.5 cN²/cm², even more preferably at most 0.8 cN²/cm², most preferably at most 0.4 cN²/cm², and in particular at most 0.2 cN²/cm²; preferably determined over at least two measurements, more preferably at least three measurements, even more preferably at least four measurements, most preferably at least five measurements, and in particular at least six measurements; preferably determined according to FINAT 10; and
optionally, wherein the first surface side of the carrier film has an embossed structure on at least part of its surface. The unit [cN²/cm²] is given in conjunction with the variance of the measured values, but the actual measured value is defined in the unit [cN/cm].

For the purpose of the description, “based on” means that it is the main component, i.e., for a layer which is based on polyolefin, polyolefin is the main component.

Release films (release liners) are known to a person skilled in the art. Release films for the purposes of the invention are preferably films based on plastic, which are used to prevent a sticky surface from adhering prematurely. They are coated on one or both sides with a release agent which has a releasing effect against sticky materials such as glue or putty. The release films according to the invention are preferably used for packaging and as a component of hygiene products, as release and surface films for applications in the construction industry, and as a release film for technical adhesive tapes and special labels.

The carrier film according to the invention preferably comprises polyester, polyamide, or polyolefin, e.g., polyethylene or polypropylene, optionally having different surface treatments. The carrier film can be stretched monoaxially or biaxially. The carrier film according to the invention can be used for various functions, which are preferably selected from the group consisting of oxygen barrier, aroma barrier, light protection, rigidity, puncture resistance, print carrier, etc.

The carrier film according to the invention can comprise a sealing layer. A sealing layer is typically used to weld the carrier film, wherein it can be welded to itself or to another film. The resulting sealing seam is preferably to remain mechanically stable and thus sealed quickly after welding. The sealing layer can thus preferably be used to control whether a packaging is later to be openable or solidly sealed.

The release film according to the invention comprises a release coating. The release coating is preferably used to release the release film from a sticky material, wherein the carrier film is the carrier for the release coating. Frequently used release agents for release coatings can be crosslinkable silicone, oils, fats, certain polyolefins, or fluorocarbons.

The carrier film according to the invention comprises at least one layer (b) and can thus, in a preferred embodiment, be a single-layer carrier film. In this embodiment, the layer (b) preferably forms both the first and the second surface side, wherein the first surface side, i.e., the layer (b), is preferably at least partially coated using the release coating.

In another preferred embodiment, the carrier film consists of a first sealing layer (a) and a layer (b) and is therefore a two-layer carrier film. In this embodiment, the first sealing layer (a) preferably forms the first surface side and layer (b) preferably forms the second surface side, wherein the first surface side, i.e., the first sealing layer (a), is preferably at least partially coated using the release coating.

In another preferred embodiment, the carrier film consists of a first sealing layer (a), a layer (b), and a second sealing layer (c) and is therefore a three-layer carrier film. In this embodiment, the first sealing layer (a) preferably forms the first surface side and the second sealing layer (c) preferably forms the second surface side, wherein the first surface side, i.e., the first sealing layer (a), is preferably at least partially coated using the release coating.

In another preferred embodiment, the carrier film consists of three identical first sealing layers (a), three identical layers (b), and three identical second sealing layers (c) and is therefore a nine-layer carrier film. In this embodiment, the first sealing layer (a) preferably forms the first surface side and the second sealing layer (c) preferably forms the second surface side, wherein the first surface side, i.e., the first sealing layer (a), is preferably at least partially coated using the release coating.

The polyolefin on which layer (b) is based is preferably selected from the group consisting of polyethylene, polypropylene, polybutylene, polyisobutylene, polyhexene, polyoctene, copolymers and/or mixtures of at least two of the polymers mentioned.

Preferably the olefin homopolymer or copolymer of layer (b) is an ethylene homopolymer or ethylene copolymer.

Preferably, the ethylene homopolymer or copolymer of layer (b) is selected from the group consisting of low density polyethylene (LDPE), linear low density polyethylene (LLDPE), medium density polyethylene (MDPE), and high density polyethylene (HDPE).

In the context of the description, ethylene homopolymer or copolymer is understood to mean ethylene homopolymers which are based exclusively on ethylene, and ethylene copolymers which, in addition to ethylene, are based on at least one further α,β-unsaturated olefin having 3 to 10 carbon atoms. Preferred ethylene homopolymers or copolymers are polyethylene having highly branched polymer chains and a low density in the range of 0.915 to 0.940 g/cm³ (LDPE); polyethylene having an average density in the range of 0.926 to 0.940 g/cm³ (MDPE); polyethylene having slightly branched polymer chains and a high density in the range of 0.945 to 0.97 g/cm³ (HDPE); and linear low-density polyethylene having short-branched polymer chains which, in addition to ethylene as a comonomer, can contain one or more higher α,β-unsaturated olefins such as butylene, hexene, or octene, having a density in the range of 0.915 to 0.94 g/cm³ (LLDPE).

The release coating preferably has a basis weight of at most 0.65 g/m²; preferably at most 0.60 g/m², more preferably at most 0.55 g/m², even more preferably at most 0.50 g/m², most preferably at most 0.45 g/m², and in particular at most 0.40 g/m²; preferably at most 0.35 g/m², more preferably at most 0.30 g/m², even more preferably at most 0.25 g/m², most preferably at most 0.20 g/m².

Preferably, the polyolefin on which layer (b) is based comprises a mixture of an ethylene homopolymer or copolymer and a propylene homopolymer or copolymer.

Preferably, the polyolefin on which layer (b) is based comprises a mixture of
51 to 85 wt. % of an ethylene homopolymer or copolymer having a density in the range of 0.91 to 0.97 g/cm³; and
15 to 49 wt. % of a propylene homopolymer or copolymer;
   each based on the total weight of the mixture.

In the context of the description, propylene homopolymer or copolymer is understood to mean propylene homopolymers which are based exclusively on propylene, and propylene copolymers which, in addition to propylene, are based on at least one further α,β-unsaturated olefin having 2 to 10 carbon atoms. Preferred propylene homopolymers are isotactic propylene homopolymers, preferably having a melting point in the range of 140 to 170° C. Preferred propylene copolymers are copolymers of propylene and ethylene, wherein the proportion of ethylene is preferably at most 20 wt. %, based on the total weight of the propylene copolymer.

Layer (b) preferably consists of LDPE and a propylene homopolymer or copolymer.

Layer (b) preferably consists of LLDPE and a propylene homopolymer or copolymer.

The release film preferably has a total layer thickness of at least 10 μm.

The optionally provided first sealing layer (a) and/or the optionally provided second sealing layer (c), each independently of one another, are preferably based on
polyolefins, wherein the polyolefin is selected from the group consisting of olefin homopolymers or copolymers of α,ß-unsaturated olefins having 2 to 10 carbon atoms; and
an ethylene-vinyl acetate copolymer.

In preferred embodiments, the optionally provided first sealing layer (a) and/or the optionally provided second sealing layer (c), each independently of one another, are based on an ethylenevinyl acetate copolymer.

In other preferred embodiments, the optionally provided first sealing layer (a) and/or the optionally provided second sealing layer (c), each independently of one another, are based on polyolefin, wherein the polyolefin is selected from the group consisting of olefin homopolymers or copolymers of α,β-unsaturated olefins having 2 to 10 carbon atoms.

In these preferred embodiments, the polyolefin of the optionally provided first sealing layer (a) and/or the optionally provided second sealing layer (c) are each independently preferably selected from the group consisting of polyethylene, polypropylene, polybutylene, polyisobutylene, polyhexene, polyoctene, copolymers and/or mixtures of at least two of the polymers mentioned.

The olefin homopolymer or copolymer of the optionally provided first sealing layer (a) and/or the optionally provided second sealing layer (c) are preferably, each independently of one another, an ethylene homopolymer or an ethylene copolymer.

The ethylene homopolymer or copolymer of the optionally provided first sealing layer (a) and/or the optionally provided second sealing layer (c) are preferably, each independently of one another, selected from the group consisting of low-density polyethylene (LDPE), linear low-density polyethylene (LLDPE), medium-density polyethylene (MDPE), high-density polyethylene (HDPE), and mixtures thereof.

The optionally provided first sealing layer (a) and/or the optionally provided second sealing layer (c), each independently of one another, preferably consist of a mixture of two ethylene homopolymers or copolymers, preferably of a mixture of LDPE with LLDPE, MDPE, or HDPE. The proportion of LDPE is preferably in the range of 10 to 85 wt. % and the proportion of the second ethylene homopolymer or copolymer is preferably in the range of 15 to 90 wt. %

The release film preferably has a total layer thickness of at least 5.0 μm; preferably at least 6.0 μm, more preferably at least 7.0 μm, even more preferably at least 8.0 μm, most preferably at least 9.0 μm, and in particular at least 10 μm.

The release film preferably has a total layer thickness in the range of 5.0 μm to 50 μm; preferably in the range of 10±5.0 μm, or 12.5±5.0 μm, or 15±5.0 μm, or 17.5±5.0 μm, or 20±5.0 μm.

The release coating preferably borders directly on the carrier film.

The second surface side of the release film is preferably not coated.

The release film preferably consists of the carrier film and the release coating.

The first surface side and optionally the second surface side are preferably each coated independently of one another by at least 10%; preferably at least 20%, preferably at least 30%, preferably at least 40%, preferably at least 50%, preferably at least 60%, more preferably at least 70%, even more preferably at least 80%, most preferably at least 90%, and in particular completely (100%).

In preferred embodiments, the carrier film is smooth.

The carrier film is preferably structured. The structuring can have different causes. On the one hand, the carrier film can be provided with a structure, i.e., by an independent process step as an active measure. On the other hand, the carrier film can have a natural structure due to its material properties.

The carrier film is preferably embossed.

The first surface side of the carrier film is preferably non-planar.

The first surface side of the carrier film preferably has an embossed structure on at least part of its surface.

The first surface side and the second surface side of the carrier film preferably each have an embossed structure on at least part of their surface.

The embossed structure preferably has a regular pattern.

The first surface side of the carrier film preferably has embossed protrusions.

The first surface side of the carrier film preferably has an average peak-to-valley height R_{z} according to DIN EN ISO 4287 of at least 5.0 μm; preferably at least 7.0 μm, more preferably at least 9.0 μm, even more preferably at least 11 μm, most preferably at least 13 μm, and in particular at least 15 μm.

The first surface side of the carrier film preferably has an average peak-to-valley height R_{z} according to DIN EN ISO 4287 of at most 100 μm; preferably at most 90 μm, more preferably at most 80 μm, even more preferably at most 70 μm, most preferably at most 60 μm, and in particular at most 50 μm.

The first surface side of the carrier film preferably has an average peak-to-valley height R_{z} according to DIN EN ISO 4287 in the range of 5.0 to 100 μm; preferably in the range of 10±5.0 μm, or 12.5±5.0 μm, or 15±5.0 μm, or 17.5±5.0 μm, or 20±5.0 μm, or 22, 5±5.0 μm, or 25±5.0 μm, or 27.5±5.0 μm, or 30±5.0 μm, or 32.5±5.0 μm, or 35±5.0 μm, or 37.5±5.0 μm, or 40±5.0 μm, or 42.5±5.0 μm, or 45±5.0 μm, or 47.5±5.0 μm, or 50±5.0 μm, or 52.5±5.0 μm, or 55±5.0 μm, or 57.5±5.0 μm, or 60±5.0 μm, or 62.5±5.0 μm, or 65±5.0 μm, or 67.5±5.0 μm, or 70±5.0 μm, or 72.5±5.0 μm, or 75±5.0 μm, or 77.5±5.0 μm, or 80±5.0 μm, or 82.5±5.0 μm, or 85±5.0 μm, or 87.5±5.0 μm, or 90±5.0 μm, or 92 0.5±5.0 μm, or 95±5.0 μm.

The carrier film is preferably printed over part or all of the surface. The carrier film is preferably printed over part or all of the surface on its first surface side.

The carrier film is preferably single-layer.

The carrier film is preferably multilayer.

The multilayer carrier film preferably consists of a total of two, three, four, five, six, seven, eight, or nine layers; preferably two or three layers.

The multilayer carrier film preferably has a symmetrical layer sequence.

In preferred embodiments, the carrier film consists of a total of three layers:
the first sealing layer (a) forming the first surface side;
layer (b); and
the second sealing layer (c) forming the second surface side.

In other preferred embodiments, the multilayer carrier film consists of a total of nine layers, wherein three layers are identical in each case.

In preferred embodiments, layer (b) forms the first surface side of the carrier film.

In these preferred embodiments, layer (b) forms the second surface side of the carrier film.

In other preferred embodiments, the first sealing layer (a) forms the first surface side of the carrier film.

In these preferred embodiments, the second sealing layer (c) forms the second surface side of the carrier film.

The carrier film is preferably based on a polyolefin mixture, or the carrier film comprises at least one layer which is based on a polyolefin mixture.

The polyolefin mixture preferably comprises at least two polyolefins which are incompatible with one another.

The carrier film preferably comprises an additive or the carrier film comprises at least one layer which comprises an additive, wherein the additive is selected from the group consisting of fillers, such as CaCO₃, plasticizers; lubricants; emulsifiers; pigments; rheology additives; catalysts; flow control agents; optical brighteners; light stabilizers; antioxidants; clarifying agents such as substituted or unsubstituted bisbenzylidene sorbitols; flame retardants; antistatic agents; UV absorbers such as benzoxazinones; propellants; and thiosynergists such as thiodipropionic acid dilauryl esters or thiodipropionic acid distearyl esters.

The carrier film preferably does not comprise a layer which is based on a nonwoven or comprises a nonwoven.

The carrier film preferably does not comprise a layer which is based on paper or comprises paper.

The release coating preferably has a basis weight of at least 0.1 g/m²; preferably at least 0.15 g/m², more preferably at least 0.2 g/m², even more preferably at least 0.25 g/m², most preferably at least 0.3 g/m², and in particular at least 0.35 g/m².

The release coating preferably has a basis weight of at most 0.6 g/m²; preferably at most 0.5 g/m², more preferably at most 0.4 g/m², even more preferably at most 0.3 g/m², and most preferably at most 0.2 g/m².

The release coating preferably has a basis weight in the range of 0.1 g/m² to 0.7 g/m²; preferably in the range of 0.3±0.2 g/m², or 0.35±0.2 g/m², or 0.4±0.2 g/m², or 0.45±0.2 g/m², or 0.5±0.2 g/m²; more preferably 0.4±0.2 g/m²; even more preferably 0.40±0.15 g/m², most preferably 0.4±0.1 g/m²; and in particular 0.40±0.05 g/m².

The release coating preferably has a layer thickness of at least 0.10 μm; preferably at least 0.15 μm, more preferably at least 0.20 μm, even more preferably at least 0.25 μm, most preferably at least 0.30 μm, and in particular at least 0.35 μm.

The release coating preferably has a layer thickness of at most 4.0 μm; preferably at most 3.5 μm, more preferably at most 3.0 μm, even more preferably at most 2.5 μm, most preferably at most 2.0 μm, and in particular at most 1.0 μm.

The release coating preferably has a layer thickness in the range of 1.0 to 4.0 μm; preferably in the range of 0.10 to 4.0 μm; preferably in the range of 0.15±0.05 μm, or 0.20±0.05 μm, or 0.25±0.05 μm, or 0.30±0.05 μm, or 0.35±0.05 μm, or 0.45±0.05 μm, or 0.50±0.05 μm, or 0.55±0.05 μm, or 0.60±0.05 μm, or 0.65±0.05 μm, or 0.70±0.05 μm, or 0.75±0.05 μm, or 0.80±0.05 μm, or 0.85±0.05 μm, or 0.90±0.05 μm, or 0.95±0.05 μm, or 1.5±0.5 μm, or 2.0±0.5 μm, or 2.5±0.5 μm, or 3.0±0, 5 μm, or 3.5±0.5 μm.

The release coating is preferably based on at least one cured polysiloxane, which is selected from the group consisting of addition-crosslinked, preferably metal-catalyzed addition-crosslinked, condensation-crosslinked, free-radically crosslinked, and/or cationically crosslinked polysiloxanes; preferably radically crosslinked polysiloxanes.

The release coating is preferably based on at least one cured polysiloxane, which is selected from the group consisting of polydialkylsiloxanes, preferably polydimethylsiloxanes; and polyalkylarylsiloxanes, preferably polymethylphenylsiloxanes; preferably chemically crosslinked acrylate-functionalized polysiloxanes; more preferably chemically crosslinked acrylate-functionalined polydialkylsiloxanes, preferably chemically crosslinked acrylate-functionalized polydimethylsiloxanes; or chemically crosslinked acrylate-functionalized polyalkylarylsiloxanes, preferably chemically crosslinked acrylate-functionalized polymethylphenylsiloxanes.

The release coating preferably comprises at least one further cured polysiloxane; preferably an acrylate-functionalized polydialkylsiloxane; preferably a chemically crosslinked long chain acrylate-functionalized polydialkylsiloxane.

According to the invention, a long-chain acrylate-functionalized polydialkylsiloxane is preferably an acrylate-functionalized polydialkylsiloxane comprising at least one C₂-6alkyl radical, which may be saturated or unsaturated and substituted or unsubstituted.

The first sealing layer (a) preferably has a layer thickness of at least 1.0 μm; preferably at least 2.0 μm, preferably at least 3.0 μm, preferably at least 4.0 μm, preferably at least 5.0 μm, more preferably at least 6.0 μm, even more preferably at least 7.0 μm, most preferably at least 8.0 μm, and in particular at least 9.0 μm.

The first sealing layer (a) preferably has a layer thickness of at most 10 μm; preferably at most 9.0 μm, more preferably at most 8.0 μm, even more preferably at most 7.0 μm, most preferably at most 6.0 μm, and in particular at most 5.0 μm.

The first sealing layer preferably has (a) a layer thickness in the range of 4.0 to 10 μm; preferably of 5.0 to 9.0 μm, and more preferably from 6.0 to 8.0 μm.

Layer (b) preferably has a layer thickness of at least 5.0 μm; preferably at least 6.0 μm, more preferably at least 8.0 μm, even more preferably at least 9.0 μm, most preferably at least 12 μm, and in particular at least 16 μm.

Layer (b) preferably has a layer thickness of at most 24.9 μm; preferably at most 22 μm, more preferably at most 20 μm, even more preferably at most 18 μm, most preferably at most 16 μm, and in particular at most 14 μm.

Layer (b) preferably has a layer thickness in the range of 5.0 to 24.9 μm; preferably of 6.0 to 22 μm, more preferably of 8.0 to 20 μm, even more preferably of 9.0 to 18 μm, and most preferably of 12 to 16 μm.

The second sealing layer (c) preferably has a layer thickness of at least 4.0 μm; preferably at least 5.0 μm, more preferably at least 6.0 μm, even more preferably at least 7.0 μm, most preferably at least 8.0 μm, and in particular at least 9.0 μm.

The second sealing layer (c) preferably has a layer thickness of at most 10 μm; preferably at most 9.0 μm, more preferably at most 8.0 μm, even more preferably at most 7.0 μm, most preferably at most 6.0 μm, and in particular at most 5.0 μm.

The second sealing layer (c) preferably has a layer thickness in the range of 4.0 to 10 μm; preferably of 5.0 to 9.0 μm, and more preferably from 6.0 to 8.0 μm.

The tensile strength of the release film in the machine direction is preferably at least 6.5 N/cm, preferably determined according to DIN EN ISO 527-3.

Preferably, the average release force of the release film is at least 2.0 cN/cm; preferably at least 4.0 cN/cm, more preferably at least 6.0 cN/cm, even more preferably at least 8.0 cN/cm, most preferably at least 10 cN/cm, and in particular at least 12 cN/cm; preferably determined according to FINAT 10, preferably in comparison to a test adhesive tape TESA® 7475 from Beiersdorf after storage for 20 h at 70° C. and at a peel speed of 300 mm/min.

Preferably, the average release force of the release film is at most 30 cN/cm; preferably at most 25 cN/cm, preferably at most 20 cN/cm, even more preferably at most 15 cN/cm, most preferably at most 10 cN/cm, and in particular at most 8.0 cN/cm; preferably determined according to FINAT 10, preferably in comparison to a test adhesive tape TESA® 7475 from Beiersdorf after storage for 20 h at 70° C. and at a peel speed of 300 mm/min.

Preferably, the average release force of the release film is in the range of 2.0 to 30 cN/cm; preferably in the range of 6.0±4.0 cN/cm, or 10±8.0 cN/cm, or 10±4.0 cN/cm, or 14±12 cN/cm, or 14±8.0 cN/cm, or 14±4.0 cN/cm, or 18±12 cN/cm, or 18±8.0 cN/cm, or 18±4.0 cN/cm, or 22±8.0 cN/cm, or 22±4.0 cN/cm, or 26±4.0 cN/cm; preferably determined according to FINAT 10, preferably compared to a test adhesive tape TESA® 7475 from Beiersdorf after storage for 20 h at 70° C. and at a peel speed of 300 mm/min.

Preferably, the difference between the maximum release force of the release valve and the average release force of the release film is at most 20 cN/cm; preferably at most 15 cN/cm, more preferably at most 12.5 cN/cm, even more preferably at most 10 cN/cm, most preferably at most 7.5 cN/cm, and in particular at most 5.0 cN/cm; preferably determined according to FINAT 10, preferably in comparison to a test adhesive tape TESA® 7475 from Beiersdorf after storage for 20 h at 70° C. and at a peel speed of 300 mm/min.

The difference between the maximum release force of the release film and the average release force of the release film is preferably in the range of 1.0 to 30 cN/cm; preferably in the range of 1.3 to 20 cN/cm, more preferably 1.6 to 16 cN/cm, even more preferably 1.9 to 13 cN/cm, most preferably 2.2 to 10 cN/cm, and in particular 2.5 to 7.0 cN/cm; preferably determined according to FINAT 10, preferably compared to a test adhesive tape TESA® 7475 from Beiersdorf after storage for 20 h at 70° C. and at a peel speed of 300 mm/min.

Preferably, the release force of the release film along the measuring section has a variance of at most 6.0 cN²/cm²; preferably at most 3.0 cN²/cm², more preferably at most 1.5 cN²/cm², even more preferably at most 0.8 cN²/cm², most preferably at most 0.4 cN²/cm², and in particular at most 0.2 cN²/cm²; preferably determined according to FINAT 10, preferably compared to a test adhesive tape TESA® 7475 from Beiersdorf after storage for 20 h at 70° C. and at a peel speed of 300 mm/min.

The release force of the release film along the measuring section preferably has a variance in the range of 0.001 to 0.7 cN²/cm²; preferably in the range of 0.002 to 0.6 cN²/cm², more preferably 0.004 to 0.5 cN²/cm², even more preferably 0.006 to 0.4 cN²/cm², most preferably 0.008 to 0.3 cN²/cm², and in particular 0.01 to 0.2 cN²/cm²; preferably determined according to FINAT 10, preferably compared to a test adhesive tape TESA® 7475 from Beiersdorf after storage for 20 h at 70° C. and at a peel speed of 300 mm/min.

Preferably, the release force of the release film over multiple measurements has a variance of at most 6.0 cN²/cm²; preferably at most 3.0 cN²/cm², more preferably at most 1.5 cN²/cm², even more preferably at most 0.8 cN²/cm², most preferably at most 0.4 cN²/cm², and in particular at most 0.2 cN²/cm²; preferably determined over at least two measurements, more preferably at least three measurements, even more preferably at least four measurements, most preferably at least five measurements, and in particular at least six measurements; preferably determined according to FINAT 10; preferably compared to a test adhesive tape TESA® 7475 from Beiersdorf after storage for 20 h at 70° C. and at a peel speed of 300 mm/min.

Preferably, the release force of the release film over multiple measurements has a variance in the range of 0.001 to 0.7 cN²/cm²; preferably in the range of 0.002 to 0.6 cN²/cm², more preferably 0.004 to 0.5 cN²/cm², even more preferably 0.006 to 0.4 cN²/cm², most preferably 0.008 to 0.3 cN²/cm², and in particular 0.01 to 0.2 cN²/cm²; preferably determined according to FINAT 10, preferably compared to a test adhesive tape TESA® 7475 from Beiersdorf after storage for 20 h at 70° C. and at a peel speed of 300 mm/min.

Preferably, the release force of the release film over the entire surface which is coated using the release coating has a variance of at most 16 cN²/cm²; preferably at most 8.0 cN²/cm², more preferably at most 4.0 cN²/cm², even more preferably at most 2.0 cN²/cm², most preferably at most 1.0 cN²/cm², and in particular at most 0.5 cN²/cm²; preferably determined according to FINAT 10, preferably compared to a test adhesive tape TESA® 7475 from Beiersdorf after storage for 20 h at 70° C. and at a peel speed of 300 mm/min.

Preferably, the release force of the release film over the entire surface which is coated using the release coating has a variance in the range of 0.001 to 0.7 cN²/cm²; preferably in the range of 0.002 to 0.6 cN²/cm², more preferably 0.004 to 0.5 cN²/cm², even more preferably 0.006 to 0.4 cN²/cm², most preferably 0.008 to 0.3 cN²/cm², and in particular 0.01 to 0.2 cN²/cm²; preferably determined according to FINAT 10, preferably compared to a test adhesive tape TESA® 7475 from Beiersdorf after storage for 20 h at 70° C. and at a peel speed of 300 mm/min.

The release film preferably has a release force which is as uniform as possible over the entire surface which is coated using the release coating.

In preferred embodiments, the polyolefin on which layer (b) is based comprises a mixture of
ethylene homopolymer or copolymer having a density in the range of 0.91 to 0.97 g/cm³; and
propylene homopolymer or copolymer;
wherein the release coating has a basis weight of at most 0.5 g/m²; and
wherein the release film has a total layer thickness of at least 10 μm.

In preferred embodiments, the polyolefin on which layer (b) is based comprises a mixture of
51 to 85 wt. % of an ethylene homopolymer or copolymer having a density in the range of 0.91 to 0.97 g/cm³; preferably LDPE; and
to 49 wt. % of a propylene homopolymer or copolymer;
each based on the total weight of the mixture;
wherein the release coating has a basis weight of at most 0.5 g/m²; and
wherein the release film has a total layer thickness of at least 10 μm.

In preferred embodiments, the polyolefin on which layer (b) is based comprises a mixture of
51 to 85 wt. % of an ethylene homopolymer or copolymer having a density in the range of 0.91 to 0.97 g/cm³; preferably LLDPE; and
15-15 to 49 wt. % of a propylene homopolymer or copolymer;
each based on the total weight of the mixture;
wherein the release coating has a basis weight of not more than 0.5 g/m² has; and
wherein the release film has a total layer thickness of at least 10 μm.

In preferred embodiments, the carrier film comprises the first sealing layer (a), which is preferably based on ethylene-vinyl acetate copolymer or ethylene homopolymer or copolymer; preferably ethylene homopolymer or copolymer; and layer (b), wherein the polyolefin on which layer (b) is based comprises a mixture of
51 to 85 wt. % of an ethylene homopolymer or copolymer having a density in the range of 0.91 to 0.97 g/cm³; preferably LDPE or LLDPE; and
15 to 49 wt. % of a propylene homopolymer or copolymer;
each based on the total weight of the mixture;
wherein the release coating has a basis weight of not more than 0.5 g/m² has; and
wherein the release film has a total layer thickness of at least 10 μm.

In preferred embodiments, the carrier film comprises
the first sealing layer (a), which is preferably based on ethylene-vinyl acetate copolymer or ethylene homopolymer or copolymer; preferably ethylene homopolymer or copolymer;
layer (b), wherein the polyolefin on which layer (b) is based comprises a mixture of
   51 to 85 wt. % of an ethylene homopolymer or copolymer having a density in the range of 0.91 to 0.97 g/cm³; preferably LDPE or LLDPE; and
   15 to 49 wt. % of a propylene homopolymer or copolymer;
   each based on the total weight of the mixture;
the second sealing layer (c), which is preferably based on ethylene-vinyl acetate copolymer or ethylene homopolymer or copolymer; preferably ethylene homopolymer or copolymer;
wherein the release coating has a basis weight of at most 0.5 g/m²; and wherein the release film has a total layer thickness of at least 10 μm.

In preferred embodiments, the carrier film comprises
the first sealing layer (a), which is based on ethylene homopolymer or copolymer;
layer (b), wherein the polyolefin on which layer (b) is based comprises a mixture of
   51 to 85 wt. % of an ethylene homopolymer or copolymer having a density in the range of 0.91 to 0.97 g/cm³; preferably LDPE or LLDPE; and
   15 to 49 wt. % of a propylene homopolymer or copolymer;
   each based on the total weight of the mixture;
the second sealing layer (c), which is based on ethylene homopolymer or copolymer;
wherein the first sealing layer (a) and the second sealing layer (c) each independently consist of a blend of two ethylene homopolymers or copolymers;
   preferably a blend of LDPE with LLDPE, MDPE, or HDPE;
      wherein the proportion of LDPE is preferably in the range of 10 to 85 wt. %; and
      wherein the proportion of the second ethylene homopolymer or copolymer is preferably in the range of 15 to 90 wt. %;
      each based on the total weight of the mixture;
wherein the release coating has a basis weight of at most 0.5 g/m²; and
wherein the release film has a total layer thickness of at least 10 μm.

A further aspect of the invention relates to a method for producing a release film by coating a carrier film using a release coating, wherein the method comprises the following steps:
(a) providing the carrier film, wherein the carrier film has a first surface side and a second surface side; wherein the carrier film is preferably structured;
(b) providing a coating composition which comprises a solvent component, preferably comprising ethyl acetate, propyl acetate, butyl acetate, and/or n-propanol, and a silicone system curable by UV radiation;
(c) coating at least a part of the first surface side of the carrier film provided in step (a) using the coating composition provided in step (b);
(d) evaporating at least a part of the solvent component; and
(e) irradiating at least a part of the first surface side of the carrier film coated in step (c) using UV radiation to cure the silicone system.

The method according to the invention is directed to the production of a release film.

In step (b) of the method according to the invention, a coating composition is provided. The coating composition comprises a solvent component and a silicone system curable by UV radiation. The coating composition is preferably used to uniformly apply a release coating in controlled thickness to the carrier film. The release coating be full surface and can completely cover the carrier film, or can only be partial surface and can partially cover the carrier film. Techniques preferably used according to the invention for coating, i.e., for applying the coating composition by which the release coating is formed after evaporation of the solvent component, are roll coating, gravure coating, multi-roll coating, reverse roll, air knife, or wire-wrapped rod.

Step (c) preferably additionally comprises coating at least part of the second surface side of the carrier film provided in step (a) using the coating composition provided in step (b) or using another coating composition.

The solvent component can consist of a single solvent or can comprise a mixture of multiple solvents. All weight and percentage data are based on the total weight of the solvent component, unless expressly described otherwise.

The silicone system curable by UV radiation can consist of a single polysiloxane or can comprise a mixture of multiple polysiloxanes. In addition to polysiloxane, the silicone system can also comprise other ingredients, for example other ingredients that contribute to the release effect, such as oils, fats, polyolefins, or fluorocarbons. All weight and percentage data are based on the total weight of the silicone system, unless expressly described otherwise.

Steps (a) to (e) are preferably carried out in alphabetical order, wherein other orders are also possible, however. For example, the order of steps (a) and (b) is immaterial. In one preferred embodiment, all steps take place one after the other. In another preferred embodiment, steps (d) and (e) take place simultaneously. In another preferred embodiment, step (d) takes place partially before step (e) and partially simultaneously with step (e). In another preferred embodiment, step (e) takes place partially before step (d) and partially simultaneously with step (d). In one preferred embodiment, step (d) takes place entirely before step (e). In another preferred embodiment, step (e) takes place entirely before step (d).

The method is preferably carried out continuously.

The silicone system curable by UV radiation is preferably radically or cationically curable.

The silicone system curable by UV radiation is preferably based on at least one polysiloxane curable by UV radiation, which is selected from the group consisting of addition-crosslinking, preferably metal-catalyzed addition-crosslinking, condensation-crosslinking, free-radically crosslinking, and/or cationically crosslinking polysiloxanes.

The release coating is preferably based on at least one cured polysiloxane, which is selected from the group consisting of polydialkylsiloxanes, preferably polydimethylsiloxanes; and polyalkylarylsiloxanes, preferably polymethylphenylsiloxanes; preferably chemically crosslinked acrylate-functionalized polysiloxanes; more preferably chemically crosslinked acrylate-functionalized polydialkylsiloxanes, preferably chemically crosslinked acrylate-functionalized polydimethylsiloxanes; or chemically crosslinked acrylate-functionalized polyalkylarylsiloxanes, preferably chemically crosslinked acrylate-functionalized polymethylphenylsiloxanes;

The content of the silicone system curable by UV radiation is preferably at least 10 wt. %, based on the total weight of the coating composition; preferably at least 20 wt. %, more preferably at least 30 wt. %, Even more preferably at least 40 wt. %, most preferably at least 50 wt. %, and in particular at least 60 wt. %.

The content of the silicone system curable by UV radiation is preferably at most 90 wt. %, based on the total weight of the coating composition; preferably at most 80 wt. %, more preferably at most 70 wt. %, more preferably at most 60 wt. %, most preferably at most 50 wt. %, and in particular at most 40 wt. %.

Preferably, the silicone system curable by UV radiation content is in the range of 10 to 90% wt. %, based on the total weight of the coating composition; preferably in the range of 20±10 wt. %, or 25±10 wt. %, or 30±10 wt. %, or 35±10 wt. %, or 40±10 wt. %, or 45±10 wt. %, or 50±10 wt. %, or 55±10 wt. %, or 60±10 wt. %, or 65±10 wt. %, or 70±10 wt. %, or 75±10 wt. %, or 80±10 wt. %.

The solvent component preferably comprises or consists of one or more C₁₋₆ alkyl acid C₁₋₆ alkyl esters.

The solvent component preferably comprises a solvent selected from the group consisting of ethyl acetate, propyl acetate, butyl acetate, and mixtures thereof.

The solvent component preferably comprises or consists of ethyl acetate.

The solvent component preferably comprises or consists of propyl acetate; preferably n-propyl acetate, isopropyl acetate, or a mixture thereof.

The solvent component preferably comprises or consists of butyl acetate; preferably n-butyl acetate, isobutyl acetate, sec-butyl acetate, tert-butyl acetate, or any mixtures thereof.

The solvent component preferably comprises or consists of one or more C₁₋₆ alkyl alcohols.

The solvent component preferably comprises or consists of a solvent which is selected from the group consisting of methanol, ethanol, propanol, butanol, ethoxypropanol, and mixtures thereof.

The solvent component preferably comprises or consists of propanol; preferably n-propanol, isopropanol, or mixtures thereof.

The solvent component preferably consists of a single solvent, i.e., there is preferably no mixture of multiple different solvents.

In other preferred embodiments, the solvent component consists of at least two solvents, i.e., a mixture of two or more different solvents is provided.

The at least two solvents of the solvent component are preferably in a ratio in the range of 5:1 to 1:1; preferably 4:1 to 1:1, preferably 3:1 to 1:1, even more preferably 2:1 to 1:1, and in particular in a ratio of 1:1.

The solvent component preferably comprises or consists of one or more C₁₋₆ alkyl acid C₁₋₆ alkyl esters and one or more C₁₋₆ alkyl alcohols.

The solvent component preferably comprises or consists of at least two solvents which are selected from the group consisting of ethyl acetate, propyl acetate, butyl acetate, methanol, ethanol, propanol, butanol, ethoxypropanol, and mixtures thereof.

The solvent component preferably comprises or consists of ethyl acetate and propanol; preferably n-propanol, isopropanol, or a mixture thereof; particularly preferably n-propanol.

In preferred embodiments, the solvent component comprises or consists of ethyl acetate and n-propanol in a ratio of 1:1.

The solvent component preferably comprises or consists of a solvent which has a molecular weight of at least 85 g/mol; preferably at least 90 g/mol, more preferably at least 95 g/mol, even more preferably at least 100 g/mol, most preferably at least 105 g/mol, and in particular at least 110 g/mol.

The solvent component preferably comprises or consists of a solvent which has a molecular weight of at most 120 g/mol, preferably at most 115 g/mol, more preferably at most 110 g/mol, even more preferably at most 105 g/mol, most preferably at most 100 g/mol, and in particular at most 95 g/mol.

The solvent component preferably comprises or consists of a solvent which has a molecular weight in the range of 85 g/mol to 120 g/mol; preferably in the range of 95±10 g/mol, or 100±10 g/mol, or 105±10 g/mol, or 110±10 g/mol.

The solvent component preferably comprises or consists of a solvent which has a boiling point of at least 70° C.; preferably at least 80° C., more preferably at least 90° C., even more preferably at least 100° C., most preferably at least 110° C., and in particular at least 120° C. According to the invention, the boiling point is preferably determined according to DIN 53171:2009-08.

The solvent component preferably comprises or consists of a solvent which has a boiling point of at most 135° C.; preferably at most 125° C., more preferably at most 115° C., even more preferably at most 105° C., most preferably at most 95° C., and in particular at most 85° C.

The solvent component preferably comprises or consists of a solvent which has a boiling point in the range of 70° C. to 135° C.; preferably in the range of 80±10° C., or 85±10° C., or 90±10° C., or 95±10° C., or 100±10° C., or 105±10° C., or 110±10° C., or 115±10° C., or 120±10° C., or 125±10° C.

The solvent component preferably comprises or consists of a solvent which has a dipole moment of at least 1.75 D; preferably at least 1.77 D, more preferably at least 1.79 D, even more preferably at least 1.81 D, most preferably at least 1.83 D, and in particular at least 1.85 D.

The solvent component preferably comprises or consists of a solvent which has a dipole moment of at most 1.90 D; preferably at most 1.88 D, more preferably at most 1.86 D, even more preferably at most 1.84 D, most preferably at most 1.82 D, and in particular at most 1.80 D.

The solvent component preferably comprises or consists of a solvent which has a dipole moment in the range of 1.75 D (5.837·10³⁰ C.m) to 1.90 D (6.337·10⁻³⁰ C.m); preferably in the range of 1.75D to 1.90D; preferably in the range of 1.77±0.02 D, or 1.78±0.02 D, or 1.79±0.02 D, or 1.80±0.02 D, or 1.81±0.05 D, or 1.82±0.02 D, or 1.83±0.05 D, or 1.84±0.02 D, or 1.85±0.02 D, or 1.86±0.02 D, or 1.87±0.02 D, or 1.88±0.02 D.

The solvent component preferably comprises or consists of a solvent which has an evaporation number of at least 2.9; preferably at least 4.0, more preferably at least 5.0, even more preferably at least 6.0, most preferably at least 7.0, and in particular at least 8.0. According to the invention, the evaporation number is preferably determined according to DIN 53170:2009-08.

The solvent component preferably comprises or consists of a solvent which has an evaporation number of at most 12; preferably at most 11, more preferably at most 10, even more preferably at most 9.0, most preferably at most 8.0, and in particular at most 7.0.

The solvent component preferably comprises or consists of a solvent which has an evaporation number in the range of 2.9 to 12; preferably in the range of 4.0±1.0, or 4.5±1.0, or 5.0±1.0, or 5.5±1.0, or 6.0±1.0, or 6.5±1.0, or 7.0±1.0, or 7.5±1.0, or 8.0±1.0, or 8.5±1.0, or 9.0±1.0, or 9.5±1.0, or 10±1.0, or 10.5±1.0, or 11±1.0.

The solvent component preferably comprises or consists of a solvent which has a dielectric constant of at least 2.40 F/m having; preferably at least 3.00 F/m, more preferably at least 3.50 F/m, even more preferably at least 4.00 F/m, most preferably at least 4.50 F/m, and in particular at least 5.00 F/m.

The solvent component preferably comprises or consists of a solvent which has a dielectric constant of at most 16.00 F/m having; preferably at most 14.40 F/m, more preferably at most 12.40 F/m, even more preferably at most 10.40 F/m, most preferably at most 8.40 F/m, and in particular at most 6.40 F/m.

The solvent component preferably comprises or consists of a solvent which has a dielectric constant in the range of 2.40 F/m to 16.00 F/m; preferably in the range of 4.50±2.00 F/m, or 5.00±2.00 F/m, or 5.50±2.00 F/m, or 6.00±2.00 F/m, or 6.50±2.00 F/m, or 7.00±2.00 F/m, or 7.50±2.00 F/m, or 8.00±2.00 F/m, or 8.50±2.00 F/m, or 9.00±2.00 F/m, or 9.50±2.00 F/m, or 10.00±2.00 F/m, or 10.50±2.00 F/m, or 11.00±2.00 F/m, or 11.50±2.00 F/m, or 12.00±2.00 F/m, or 12.50±2.00 F/m, or 13.00±2.00 F/m, or 13.50±2.00 F/m, or 14.00±2.00 F/m.

The solvent component preferably comprises or consists of a solvent which has a viscosity of at least 0.30 mm²/s having; preferably at least 0.32 mm²/s, more preferably at least 0.34 mm²/s, even more preferably at least 0.36 mm²/s, most preferably at least 0.38 mm²/s, and in particular at least 0.40 mm²/s.

The solvent component preferably comprises or consists of a solvent which has a maximum viscosity of 0.8 mm²/s; preferably at most 0.78 mm²/s, more preferably at most 0.76 mm²/s, even more preferably at most 0.74 mm²/s, most preferably at most 0.72 mm²/s, and in particular at most 0.70 mm²/s.

The solvent component preferably comprises or consists of a solvent which has a viscosity 30 in the range of 0.3 mm²/s to 0.8 mm²/s; preferably in the range of 0.4±0.1 mm²/s, or 0.45±0.1 mm²/s, or 0.5±0.1 mm²/s, or 0.55±0.1 mm²/s, or 0.6±0.1 mm²/s, or 0.65±0.1 mm²/s, or 0.7±0.1 mm²/s.

The solvent component preferably comprises or consists of a solvent which has a surface tension of at least 22 mN/m; preferably at least 22.2 mN/m, more preferably at least 22.4 mN/m, even more preferably at least 22.6 mN/m, most preferably at least 22.8 mN/m, and in particular at least 23 mN/m.

The solvent component preferably comprises or consists of a solvent which has a surface tension of at most 26 mN/m; preferably at most 25.9 mN/m, more preferably at most 25.8 mN/m, even more preferably at most 25.7 mN/m, most preferably at most 25.6 mN/m, and in particular at most 25.5 mN/m.

The solvent component preferably comprises or consists of a solvent which has a surface tension in the range of 22 mN/m to 26 mN/m; preferably in the range of 22.6±0.5 mN/m, or 22.8±0.5 mN/m, or 23±0.5 mN/m, or 23.2±0.5 mN/m, or 23.4±0.5 mN/m, or 23.6±0.5 mN/m, or 23.8±0.5 mN/m, or 24±0.5 mN/m, or 24.2±0.5 mN/m, or 24.4±0.5 mN/m, or 24.6±0.5 mN/m, or 24.8±0.5 mN/m, or 25±0.5 mN/m, or 25.2±0.5 mN/m, or 25.4±0.5 mN/m.

The solvent component preferably comprises or consists of a solvent which has a flash point of at least −5.0° C.; preferably at least −1.0° C., more preferably at least 3.0° C., even more preferably at least 7.0° C., most preferably at least 11° C., and in particular at least 15° C. According to the invention, the flash point is preferably determined according to DIN EN ISO 2719:2016-11.

The solvent component preferably comprises or consists of a solvent which has a flash point of at most 30° C.; preferably at most 26° C., more preferably at most 22° C., even more preferably at most 18° C., most preferably at most 14° C., and in particular at most 10° C.

The solvent component preferably comprises or consists of a solvent which has a flash point in the range of −5.0° C. to 30° C.; preferably in the range of −1.0±4.0° C., or 1.0±4.0° C., or 3.0±4.0° C., or 5.0±4.0° C., or 7.0±4.0° C., or 9.0±4.0° C., or 11±4.0° C., or 13±4.0° C., or 15±4.0° C., or 17±4.0° C., or 19±4.0° C., or 21±4.0° C., or 23±4.0° C., or 25±4.0° C.

The solvent component preferably comprises or consists of a solvent which has an ignition temperature of at least 350° C.; preferably at least 370° C., more preferably at least 390° C., even more preferably at least 410° C., most preferably at least 430° C., and in particular at least 450° C. According to the invention, the ignition temperature is determined according to DIN EN 14522:2005-12.

The solvent component preferably comprises or consists of a solvent which has an ignition temperature of at most 470° C.; preferably at most 450° C., more preferably at most 430° C., even more preferably at most 410° C., most preferably at most 390° C., and in particular at most 370° C.

The solvent component preferably comprises or consists of a solvent which has an ignition temperature in the range of 350° C. to 470° C.; preferably in the range of 370±20° C., or 380±20° C., or 390±20° C., or 400±20° C., or 410±20° C., or 420±20° C., or 430±20° C., or 440±20° C., or 450±20° C.

The solvent component preferably comprises or consists of a solvent which has a polarity of at least 155 kJ/mol; preferably at least 156 kJ/mol, more preferably at least 157 kJ/mol, even more preferably at least 158 kJ/mol, most preferably at least 159 kJ/mol, and in particular at least 160 kJ/mol.

The solvent component preferably comprises or consists of a solvent which has a polarity of at most 162 kJ/mol; preferably at most 161 kJ/mol, more preferably at most 160 kJ/mol, even more preferably at most 159 kJ/mol, most preferably at most 158 kJ/mol, and in particular at most 157 kJ/mol.

The solvent component preferably comprises or consists of a solvent which has a polarity in the range of 155 kJ/mol to 162 kJ/mol; preferably in the range of 156±1.0 kJ/mol, or 156.5±1.0 kJ/mol, or 157±1.0 kJ/mol, or 157.5±1.0 kJ/mol, or 158±1.0 kJ/mol, or 158.5±1.0 kJ/mol, or 159±1.0 kJ/mol, or 159.5±1.0 kJ/mol, or 160±1.0 kJ/mol, or 160.5±1.0 kJ/mol, or 161±1.0 kJ/mol.

The content of the solvent component is preferably at least 10 wt. %, based on the total weight of the coating composition; preferably at least 20 wt. %, more preferably at least 30 wt. %, Even more preferably at least 40 wt. %, most preferably at least 50 wt. %, and in particular at least 60 wt. %.

The content of the solvent component is preferably at most 90 wt. %, based on the total weight of the coating composition; preferably at most 80 wt. %, more preferably at most 70 wt. %, more preferably at most 60 wt. %, most preferably at most 50 wt. %, and in particular at most 40 wt. %.

Preferably, the content of the solving component is in the range of 10 to 90% wt. %, based on the total weight of the coating composition; preferably in the range of 20±10 wt. %, or 25±10 wt. %, or 30±10 wt. %, or 35±10 wt. %, or 40±10 wt. %, or 45±10 wt. %, or 50±10 wt. %, or 55±10 wt. %, or 60±10 wt. %, or 65±10 wt. %, or 70±10 wt. %, or 75±10 wt. %, or 80±10 wt. %.

The coating composition is preferably adjusted to a specific viscosity. The amount of solvent component added is used to set the desired viscosity. The amount of a specific solvent component required to adjust a specific coating composition to a specific viscosity depends on the nature of the solvent component and the other components of the coating composition and can be determined by simple routine experimentation.

The coating composition preferably has a viscosity of at least 1.0 mm²/s; preferably at least 1.5 mm²/s, more preferably at least 2.0 mm²/s, even more preferably at least 2.5 mm²/s, most preferably at least 3.0 mm²/s, and in particular at least 3.5 mm²/s.

The coating composition preferably has a viscosity of at most 100 mm²/s; preferably at most 90 mm²/s, more preferably at most 80 mm²/s, even more preferably at most 70 mm²/s, most preferably 60 mm²/s, and in particular at most 50 mm²/s. The coating composition preferably has a viscosity of at most 20 mm²/s; preferably at most 19 mm²/s, more preferably at most 18 mm²/s, even more preferably at most 17 mm²/s, most preferably 16 mm²/s, and in particular at most 15 mm²/s.

The coating composition preferably has a viscosity in the range of 1.0 to 100 mm 2/5; preferably in the range of 15±10 mm 2/s, or 20±10 mm 2/s, or 25±10 mm 2/s, or 30±10 mm 2/s, or 35±10 mm 2/s, or 40±10 mm 2/s, or 45±10 mm 2/s, or 50±10 mm 2/s, or 55±10 mm 2/s, or 60±10 mm 2/s, or 65±10 mm 2/s, or 70±10 mm 2/s, or 75±10 mm 2/s, or 80±10 mm 2/s, or 85±10 mm²/s, or 90±10 mm²/s.

In preferred embodiments, the coating composition has a viscosity
(i) of at least 2.0 mm²/s; preferably at least 4.0 mm²/s, more preferably at least 6.0 mm²/s, even more preferably at least 8.0 mm²/s, most preferably at least 10 mm²/s, and in particular at least 12 mm²/s; and/or
(ii) of at most 20 mm²/s; preferably at most 19 mm²/s, more preferably at most 18 mm²/s, even more preferably at most 17 mm²/s, most preferably 16 mm²/s, and in particular at most 15 mm²/s; and/or
(iii) in the range of 2.0 to 20 mm²/s; preferably in the range of 4.0±2.0 mm²/s, or 6.0±4.0 mm²/s, or 6.0±2.0 mm²/s, or 8.0±6.0 mm²/s, or 8.0±4.0 mm²/s, or 8.0±2.0 mm²/s, or 10±8.0 mm²/s, or 10±6.0 mm²/s, or 10±4.0 mm²/s, or 10±2.0 mm²/s, or 12±8.0 mm²/s, or 12±6.0 mm²/s, or 12±4.0 mm²/s, or 12±2.0 mm²/s, or 14±6.0 mm²/s, or 14±4.0 mm²/s, or 14±2.0 mm²/s, or 16±4.0 mm²/s, or 16±2.0 mm²/s, or 18±2.0 mm²/s.

In preferred embodiments, the coating composition has a viscosity
(i) of at least 2.0 mm²/s; preferably at least 4.0 mm²/s, more preferably at least 6.0 mm²/s, even more preferably at least 8.0 mm²/s, most preferably at least 10 mm²/s, and in particular at least 12 mm²/s; and/or
(ii) of at most 40 mm²/s auf; preferably at most 38 mm²/s, more preferably at most 36 mm²/s, even more preferably at most 34 mm²/s, most preferably 32 mm²/s, and in particular at most 30 mm²/s; and/or
(iii) in the range of 2.0 to 40 mm²/s; preferably in the range of 10±5 mm²/s, or 15±10 mm²/s, or 15±5 mm²/s, or 20±15 mm²/s, or 20±10 mm²/s, or 20±5 mm²/s, or 25±15 mm²/s, or 25±10 mm²/s, or 25±5 mm²/s, or 30±10 mm²/s, or 30±5 mm²/s, or 35±5 mm²/s.

In other preferred embodiments, the coating composition has a viscosity
(i) of at least 20 mm²/s; preferably at least 22 mm²/s, more preferably at least 24 mm²/s, even more preferably at least 26 mm²/s, most preferably at least 28 mm²/s, and in particular at least 30 mm²/s; and/or
(ii) of at most 60 mm²/s auf; preferably at most 58 mm²/s, more preferably at most 56 mm²/s, even more preferably at most 54 mm²/s, most preferably 52 mm²/s, and in particular at most 50 mm²/s; and/or
(iii) in the range of 20 to 60 mm²/s; preferably in the range of 25±5 mm²/s, or 30±10 mm²/s, or 30±5 mm²/s, or 35±15 mm²/s, or 35±10 mm²/s, or 35±5 mm²/s, or 40±20 mm²/s, or 40±15 mm²/s, or 40±10 mm²/s, or 40±5 mm²/s, or 45±15 mm²/s, or 45±10 mm²/s, or 45±5 mm²/s, or 50±10 mm²/s, or 50±5 mm²/s.

In other preferred embodiments, the coating composition has a viscosity
(i) of at least 40 mm²/s; preferably at least 42 mm²/s, more preferably at least 44 mm²/s, even more preferably at least 46 mm²/s, most preferably at least 48 mm²/s, and in particular at least 50 mm²/s; and/or
(ii) of at most 80 mm²/s auf; preferably at most 78 mm²/s, more preferably at most 76 mm²/s, even more preferably at most 74 mm²/s, most preferably 72 mm²/s, and in particular at most 70 mm²/s; and/or
(iii) in the range of 40 to 80 mm²/s; preferably in the range of 45±5 mm²/s, or 50±10 mm²/s, or 50±5 mm²/s, or 55±15 mm²/s, or 55±10 mm²/s, or 55±5 mm²/s, or 60±20 mm²/s, or 60±15 mm²/s, or 60±10 mm²/s, or 60±5 mm²/s, or 65±15 mm²/s, or 65±10 mm²/s, or 65±5 mm²/s, or 70±10 mm²/s, or 70±5 mm²/s.

In other preferred embodiments, the coating composition has a viscosity
(i) of at least 60 mm²/s; preferably at least 62 mm²/s, more preferably at least 64 mm²/s, even more preferably at least 66 mm²/s, most preferably at least 68 mm²/s, and in particular at least 70 mm²/s; and/or
(ii) of at most 100 mm²/s auf; preferably at most 98 mm²/s, more preferably at most 96 mm²/s, even more preferably at most 94 mm²/s, most preferably 92 mm²/s, and in particular at most 90 mm²/s; and/or
(iii) in the range of 60 to 100 mm²/s; preferably in the range of 65±5 mm²/s, or 70±10 mm²/s, or 70±5 mm²/s, or 75±15 mm²/s, or 75±10 mm²/s, or 75±5 mm²/s, or 80±20 mm²/s, or 80±15 15 mm²/s, or 80±10 mm²/s, or 80±5 mm²/s, or 85±15 mm²/s, or 85±10 mm²/s, or 85±5 mm²/s, or 90±10 mm²/s, or 90±5 mm²/s.

In other preferred embodiments, the coating composition has a viscosity
(i) of at least 80 mm²/s; preferably at least 82 mm²/s, more preferably at least 84 mm²/s, even more preferably at least 86 mm²/s, most preferably at least 88 mm²/s, and in particular at least 90 mm²/s; and/or
(ii) of at most 120 mm²/s; preferably at most 118 mm²/s, more preferably at most 116 mm²/s, even more preferably at most 114 mm²/s, most preferably 112 mm²/s, and in particular at most 110 mm²/s; and/or
(iii) in the range of 80 to 120 mm²/s; preferably in the range of 85±5 mm²/s, or 90±10 mm²/s, or 90±5 mm²/s, or 95±15 mm²/s, or 95±10 mm²/s, or 95±5 mm²/s, or 100±20 mm²/s, or 100±15 mm²/s, or 100±10 mm²/s, or 100±5 mm²/s, or 105±15 mm²/s, or 105±10 mm²/s, or 105±5 mm²/s, or 110±10 mm²/s, or 110±5 mm²/s.

In other preferred embodiments, the coating composition has a viscosity
(i) of at least 100 mm²/s; preferably at least 102 mm²/s, more preferably at least 104 mm²/s, even more preferably at least 106 mm²/s, most preferably at least 108 mm²/s, and in particular at least 110 mm²/s; and/or
(ii) of at most 140 mm²/s auf; preferably at most 138 mm²/s, more preferably at most 136 mm²/s, even more preferably at most 134 mm²/s, most preferably 132 mm²/s, and in particular at most 130 mm²/s; and/or
(iii) in the range of 100 to 140 mm²/s; preferably in the range of 105±5 mm²/s, or 110±10 mm²/s, or 110±5 mm²/s, or 115±15 mm²/s, or 115±10 mm²/s, or 115±5 mm²/s, or 120±20 mm²/s, or 120±15 mm²/s, or 120±10 mm²/s, or 120±5 mm²/s, or 125±15 mm²/s, or 125±10 mm²/s, or 125±5 mm²/s, or 130±10 mm²/s, or 130±5 mm²/s.

In other preferred embodiments, the coating composition has a viscosity
(i) of at least 120 mm²/s; preferably at least 122 mm²/s, more preferably at least 124 mm²/s, even more preferably at least 126 mm²/s, most preferably at least 128 mm²/s, and in particular at least 130 mm²/s; and/or
(ii) of at most 160 mm²/s auf; preferably at most 158 mm²/s, more preferably at most 156 mm²/s, even more preferably at most 154 mm²/s, most preferably 152 mm²/s, and in particular at most 150 mm²/s; and/or
(iii) in the range of 120 to 160 mm²/s; preferably in the range of 125±5 mm²/s, or 130±10 mm²/s, or 130±5 mm²/s, or 135±15 mm²/s, or 135±10 mm²/s, or 135±5 mm²/s, or 140±20 mm²/s, or 140±15 mm²/s, or 140±10 mm²/s, or 140±5 mm²/s, or 145±15 mm²/s, or 145±10 mm²/s, or 145±5 mm²/s, or 150±10 mm²/s, or 150±5 mm²/s.

In other preferred embodiments, the coating composition has a viscosity
(i) of at least 140 mm²/s; preferably at least 142 mm²/s, more preferably at least 144 mm²/s, even more preferably at least 146 mm²/s, most preferably at least 148 mm²/s, and in particular at least 150 mm²/s; and/or
(ii) of at most 180 mm²/s auf; preferably at most 178 mm²/s, more preferably at most 176 mm²/s, even more preferably at most 174 mm²/s, most preferably 172 mm²/s, and in particular at most 170 mm²/s; and/or
(iii) in the range of 140 to 180 mm²/s; preferably in the range of 145±5 mm²/s, or 150±10 mm²/s, or 150±5 mm²/s, or 155±15 mm²/s, or 155±10 mm²/s, or 155±5 mm²/s, or 160±20 mm²/s, or 160±15 mm²/s, or 160±10 mm²/s, or 160±5 mm²/s, or 165±15 mm²/s, or 165±10 mm²/s, or 165±5 mm²/s, or 170±10 mm²/s, or 170±5 mm²/s.

In other preferred embodiments, the coating composition has a viscosity
(i) of at least 160 mm²/s; preferably at least 162 mm²/s, more preferably at least 164 mm²/s, even more preferably at least 166 mm²/s, most preferably at least 168 mm²/s, and in particular at least 170 mm²/s; and/or
(ii) of at most 200 mm²/s auf; preferably at most 198 mm²/s, more preferably at most 196 mm²/s, even more preferably at most 194 mm²/s, most preferably 192 mm²/s, and in particular at most 190 mm²/s; and/or
(iii) in the range of 160 to 200 mm²/s; preferably in the range of 165±5 mm²/s, or 170±10 mm²/s, or 170±5 mm²/s, or 175±15 mm²/s, or 175±10 mm²/s, or 175±5 mm²/s, or 180±20 mm²/s, or 180±15 mm²/s, or 180±10 mm²/s, or 180±5 mm²/s, or 185±15 mm²/s, or 185±10 mm²/s, or 185±5 mm²/s, or 190±10 mm²/s, or 190±5 mm²/s.

In other preferred embodiments, the coating composition has a viscosity
(i) of at least 180 mm²/s; preferably at least 182 mm²/s, more preferably at least 184 mm²/s, even more preferably at least 186 mm²/s, most preferably at least 188 mm²/s, and in particular at least 190 mm²/s; and/or
(ii) of at most 220 mm²/s; preferably at most 218 mm²/s, more preferably at most 216 mm²/s, even more preferably at most 214 mm²/s, most preferably 212 mm²/s, and in particular at most 210 mm²/s; and/or
(iii) in the range of 180 to 220 mm²/s; preferably in the range of 185±5 mm²/s, or 190±10 mm²/s, or 190±5 mm²/s, or 195±15 mm²/s, or 195±10 mm²/s, or 195±5 mm²/s, or 200±20 mm²/s, or 200±15 mm²/s, or 200±10 mm²/s, or 200±5 mm²/s, or 205±15 mm²/s, or 205±10 mm²/s, or 205±5 mm²/s, or 210±10 mm²/s, or 210±5 mm²/s.

In other preferred embodiments, the coating composition has a viscosity in the range of 5 mm²/s to 220 mm²/s; preferably in the range of 50±45 mm²/s, or 50±40 mm²/s, or 50±35 mm²/s, or 50±30 mm²/s, or 50±25 mm²/s, or 50±20 mm²/s, or 50±15 mm²/s, or 50±10 mm²/s, or 50±5 mm²/s, or 100±90 mm²/s, or 100±80 mm²/s, or 100±70 mm²/s, or 100±60 mm²/s, or 100±50 mm²/s, or 100±40 mm²/s, or 100±30 mm²/s, or 100±20 mm²/s, or 100±10 mm²/s, or 150±135 mm²/s, or 150±120 mm²/s, or 150±105 mm²/s, or 150±90 mm²/s, or 150±75 mm²/s, or 150±60 mm²/s, or 150±45 mm²/s, or 150±30 mm²/s, or 150±15 mm²/s, or 200±180 mm²/s, or 200±160 mm²/s, or 200±140 mm²/s, or 200±120 mm²/s, or 200±100 mm²/s, or 200±80 mm²/s, or 200±60 mm²/s, or 200±40 mm²/s, or 200±20 mm²/s.

According to the invention, particularly advantageous results were achieved with viscosities of 20 mm²/s and less.

The viscosity of the coating composition according to the invention is determined at 23° C. The viscosity described above is the kinematic viscosity. Unless expressly stated otherwise, all viscosity values are kinematic viscosities.

Alternatively, the viscosity of the coating composition according to the invention can also be expressed as a dynamic viscosity, wherein the value for the dynamic viscosity in mPa·s corresponds to the value for the kinematic viscosity in mm²/s if the density is 1.00 g/cm³. The density of the coating composition according to the invention can deviate from 1.00 g/cm³. The preferred numerical values mentioned above also apply correspondingly to the preferred ranges of the dynamic viscosity at 23° C..

The viscosity of the coating composition is preferably determined using a measuring cup in accordance with DIN EN ISO 2431 or ASTM D 5125. Alternatively, the viscosity can also be determined according to DIN EN ISO 453. A measuring cup having an outlet opening of 6 mm is preferably used; preferably 5 mm, more preferably 4 mm, and particularly preferably 3 mm. The international standard (DIN EN ISO 2431) describes a method for determining the flow time using a 4 mm cup, the dimensions of which deviate from the DIN 53 211 cup. A longer nozzle, a larger inlet cone, and slightly different internal dimensions result in different flow times than with cups according to DIN 53 211. This also expands the measuring range, so that the DIN EN ISO cup represents a useful addition to the DIN cup. The measuring method is fundamentally the same as for the DIN cup. According to the invention, the following DIN EN ISO cups are preferably used for the following value ranges:

| | | |
|---|---|---|
| 3 mm | viscosity 10-40 mm²/s = | 30-100 sec |
| 4 mm | viscosity 25-130 mm²/s = | 25-100 sec |
| 5 mm | viscosity 70-360 mm²/s = | 25-100 sec |
| 6 mm | viscosity 130-700 mm²/s = | 25-100 sec |

The coating composition preferably has a flow time from a measuring cup of at least 5.0 s; preferably at least 10 s, more preferably at least 12 s, even more preferably at least 14 s, most preferably at least 16 s, and in particular at least 18 s; preferably determined using a measuring cup having an outlet opening of 3 mm; preferably determined having a measuring cup according to DIN EN ISO 2431.

The coating composition preferably has a flow time from a measuring cup of at most 30 s; preferably at most 29 s, more preferably at most 28 s, even more preferably at most 27 s, most preferably at most 26 s, and in particular at most 25 s; preferably determined using a measuring cup having an outlet opening of 3 mm; preferably determined using a measuring cup according to DIN EN ISO 2431.

The coating composition preferably has a flow time from a measuring cup of at most 25 s; preferably at most 24 s, more preferably at most 23 s, even more preferably at most 22 s, most preferably at most 21 s, and in particular at most 20 s; preferably determined using a measuring cup having an outlet opening of 3 mm; preferably determined using a measuring cup according to DIN EN ISO 2431.

Preferably, the coating composition has a flow time from a measuring cup in the range of 5.0 to 30 seconds; preferably in the range of 8.0 to 28 s; more preferably 11 to 26 s, even more preferably 14 to 24 s, most preferably 16 to 23 s, and in particular 18 to 22 s; preferably determined using a measuring cup having an outlet opening of 3 mm; preferably determined using a measuring cup according to DIN EN ISO 2431.

Preferably, the coating composition has a flow time from a measuring cup in the range of 5.0 to 30 seconds; preferably in the range of 7.0±2.0 s, or 9.0±4.0 s, or 9.0±2.0 s, or 11±6.0 s, or 11±4.0 s, or 11±2.0 s, or 13±8.0 s, or 13±6.0 s, or 13±4.0 s, or 13±2.0 s, or 15±10 s, or 15±8, 0 s, or 15±6.0 s, or 15±4.0 s, or 15±2.0 s, or 17±12 s, or 17±10 s, or 17±8.0 s, or 17±6.0 s, or 17±4.0 s, or 17±2.0 s, or 19±10 s, or 19±8.0 s, or 19±6.0 s, or 19±4.0 s, or 19±2.0 s, or 21±8.0 s, or 21±6.0 s, or 21±4.0 s, or 21±2.0 s, or 23±6.0 s, or 23±4.0 s, or 23±2.0 s, or 25±4.0 s, or 25±2.0 s, or 27±2.0 s; preferably determined using a measuring cup having an outlet opening of 3 mm; preferably determined using a measuring cup according to DIN EN ISO 2431.

The coating composition preferably contains a catalyst which catalyzes the curing of the polysiloxane curable by UV radiation.

The catalyst is preferably selected from the group consisting of α-hydroxy, α-alkoxy or α-amino aryl ketones, acylphosphine oxides, aliphatic azo compounds, or onium compounds.

Preferably step (c) comprises cooling the coating composition. In this way, the evaporation process of the solvent component in the solvent-containing formulation of the coating composition can be counteracted.

The coating in step (c) preferably takes place at a temperature of at least 5.0° C.; preferably at least 7.0° C., more preferably at least 9.0° C., even more preferably at least 11° C., most preferably at least 13° C., and in particular at least 15° C.

The coating in step (c) preferably takes place at a temperature of at most 20° C.; preferably at most 18° C., more preferably at most 16° C., even more preferably at most 14° C., most preferably at most 12° C., and in particular at most 10° C.

The coating in step (c) preferably takes place at a temperature in the range of 5.0° C. to 20° C.; preferably in the range of 6.0±2.0° C., or 7.0±2.0° C., or 8.0±2.0° C., or 9.0±2.0° C., or 10±2.0° C., or 11±2.0° C., or 12±2.0° C., or 13±2.0° C., or 14±2.0° C., or 15±2.0° C., or 16±2.0° C., or 17±2.0° C., or 18±2.0° C.

Step (c) preferably comprises applying the coating composition to at least part of the first surface side of the carrier film using a printing method, preferably a flexographic printing method. Alternatively, however, gravure printing methods or multi-roller application methods are also possible, in particular if a smooth carrier film is used.

Step (c) preferably comprises applying the coating composition to at least part of the first surface side of the carrier film using an anilox roller.

The scoop volume of the anilox roller used in step (c) to apply the coating composition is preferably at least 1.0 cm³/m², preferably at least 2.0 cm³/m², more preferably at least 3.0 cm³/m², even more preferably at least 4.0 cm³/m², and most preferably at least 5.0 cm³/m².

The scoop volume of the anilox roller used in step (c) to apply the coating composition is preferably at most 10 cm³/m², preferably at most 9.0 cm³/m², more preferably at most 8.0 cm³/m², even more preferably at most 7.0 cm³/m², and most preferably at most 6.0 cm³/m².

The scoop volume of the anilox roller used in step (c) to apply the coating composition is preferably in the range of 1.0 to 9.0 cm³/m², preferably 2.0 to 8.0 cm³/m², more preferably 3.0 to 7.0 cm³/m², even more preferably 4.0 to 6.0 cm³/m², and most preferably 4.5 to 5.5 cm³/m².

Preferably, step (c) comprises coating at least 50% of the first surface side; preferably at least 60%, more preferably at least 70%, more preferably at least 80%, most preferably at least 90%, and in particular completely (100%).

The evaporation of the solvent component in step (d) preferably takes place at a temperature of at least 30° C.; preferably at least 40° C., more preferably at least 50° C., even more preferably at least 60° C., most preferably at least 70° C., and in particular at least 80° C.

The evaporation of the solvent component in step (d) preferably takes place at a temperature of at most 180° C.; preferably at most 170° C., more preferably at most 160° C., even more preferably at most 150° C., most preferably at most 140° C., and in particular at most 130° C.

The evaporation of the solvent component in step (d) preferably takes place at a temperature in a range of 30° C. to 180° C.; preferably in the range of 50±20° C., or 60±20° C., or 70±20° C., or 80±20° C., or 90±20° C., or 100±20° C., or 110±20° C., or 120±20° C., or 130±20° C., or 140±20° C., or 150±20° C., or 160±20° C.

The evaporation of the solvent component in step (d) preferably takes place at a pressure of at least 100 mbar; preferably at least 150 mbar, more preferably at least 200 mbar, even more preferably at least 250 mbar, most preferably at least 300 mbar, and in particular at least 350 mbar.

The evaporation of the solvent component in step (d) preferably takes place at a pressure of at most 900 mbar; preferably at most 850 mbar, more preferably at most 800 mbar, even more preferably at most 750 mbar, most preferably at most 700 mbar, and in particular at most 650 mbar.

The evaporation of the solvent component in step (d) preferably takes place at a pressure in the range of 100 mbar to 900 mbar; preferably in the range of 150±50 mbar, or 200±50 mbar, or 250±50 mbar, or 300±50 mbar, or 350±50 mbar, or 400±50 mbar, or 450±50 mbar, or 500±50 mbar, or 550±50 mbar, or 600±50 mbar, or 650±50 mbar, or 700±50 mbar, or 750±50 mbar, or 800±50 mbar, or 850±50 mbar.

Step (d) preferably comprises evaporating the solvent component to odor neutrality.

The solvent component is preferably evaporating step (d) down to a residual content of the solvent component of at most 100 ppmw; preferably at most 80 ppmw, more preferably at most 60 ppmw, even more preferably at most 40 ppmw, most preferably at most 20 ppmw, in particular completely (0 ppmw).

At least part of the coated first surface side of the carrier film is preferably irradiated in step (e) for at least 0.02 s; preferably at least 0.04 s, more preferably at least 0.06 s, even more preferably at least 0.08 s, most preferably at least 0.1 s, and in particular at least 1.2 s.

At least part of the coated first surface side of the carrier film is preferably irradiated in step (e) for at most 5.0 s; preferably at most 4.5 s, more preferably at most 4.0 s, even more preferably at most 3.5 s, most preferably at most 3.0 s, and in particular at most 2.5 s.

At least part of the coated first surface side of the carrier film is preferably irradiated in step (e) for a period of time of 0.02 s to 5.0 s; preferably for a period of time of 0.06±0.04 s, or 0.08±0.04 s, or 0.1±0.04 s, or 0.12±0.04 s, or 0.14±0.04 s, or 0.16±0.04 s, or 0.18±0.04 s, or 0.2±0.04 s, or 0.22±0.04 s, or 0.24±0.04 s, or 0.26±0.04 s, or 0.28±0.04 s, or 0.30±0.04 s, or 0.32±0.04 s, or 0.34±0.04 s, or 0.36±0.04 s, or 0.38±0.04 s, or 0.40±0.04 s, or 0.42±0.04 s, or 0.44±0.04 s, or 0.46±0.04 s.

At least part of the coated first surface side of the carrier film is preferably irradiated in step (e) using electromagnetic radiation selected from electron beams and UV rays, preferably UV rays.

At least part of the coated first surface side of the carrier film is preferably irradiated in step (e) at a wavelength of at least 170 nm; preferably at least 190 nm, more preferably at least 210 nm, even more preferably at least 230 nm, most preferably at least 250 nm, and in particular at least 270 nm.

At least part of the coated first surface side of the carrier film is preferably irradiated in step (e) at a wavelength of at most 400 nm; preferably at most 380 nm, more preferably at most 360 nm, even more preferably at most 340 nm, most preferably at most 320 nm, and in particular at most 300 nm.

At least part of the coated first surface side of the carrier film is preferably irradiated in step (e) at a wavelength in the range of 170 nm to 400 nm; preferably in the range of 190±20 nm, or 200±20 nm, or 210±20 nm, or 220±20 nm, or 230±20 nm, or 240±20 nm, or 250±20 nm, or 260±20 nm, or 270±20 nm, or 280±20 nm, or 290±20 nm, or 300±20 nm, or 310±20 nm, or 320±20 nm, or 330±20 nm, or 340±20 nm, or 350±20 nm, or 360±20 nm, or 370±20 nm, or 380±20 nm.

At least part of the coated first surface side of the carrier film is preferably irradiated in step (e) using an energy of at least 3.0 eV; preferably at least 4.0 eV, more preferably at least 5.0 eV, even more preferably at least 6.0 eV, most preferably at least 7.0 eV, and in particular at least 8.0 eV.

At least part of the coated first surface side of the carrier film is preferably irradiated in step (e) using an energy of at most 12 eV; preferably at most 11 eV, more preferably at most 10 eV, even more preferably at most 9.0 eV, most preferably at most 8.0 eV, and in particular at most 7.0 eV.

At least part of the coated first surface side of the carrier film is preferably irradiated in step (e) using an energy in the range of 3.0 eV to 12 eV; preferably in the range of 5.0±2.0 eV, or 6.0±2.0 eV, or 7.0±2.0 eV, or 8.0±2.0 eV, or 9.0±2, 0 eV, or 10±2.0 eV.

At least part of the coated first surface side of the carrier film is preferably irradiated in step (e) under a protective gas atmosphere.

The protective gas atmosphere preferably essentially comprises nitrogen.

Preferably, step (e) comprises irradiating at least 50% of the coated first surface side; preferably at least 60%, more preferably at least 70%, more preferably at least 80%, most preferably at least 90%, and in particular completely (100%).

Step (a) preferably additionally comprises the surface activation of at least the first surface side of the carrier film provided in (a).

The surface activation is preferably carried out by pretreatment using plasma or corona.

A further aspect of the invention relates to a release film comprising
a carrier film, which has a first surface side and a second surface side; and
a release coating;
wherein the first surface side of the carrier film is at least partially coated using the release coating; and
wherein the release film is obtainable by the method according to the invention described above.

The release film obtainable by the process according to the invention differs from conventional release films in its microstructure. In contrast to release films, which were first coated using the release coating and then structured, the release film according to the invention has a more uniform coating having fewer defects. In contrast to release films in which structured carrier films have been coated using conventional coating compositions, the release film according to the invention also has a more even coating having fewer defects and, moreover, preferably a lower basis weight of the release coating.

A further aspect of the invention relates to the use of the release film according to the invention as described above as a detachable release and/or protective film for adhesive hygiene items.

Preferred embodiments 1 to 103 according to the invention are summarized hereinafter: 1. A method for producing a release film by coating a carrier film using a release coating, wherein the method comprises the following steps: (a) providing the carrier film, wherein the carrier film has a first surface side and a second surface side, wherein the carrier film is preferably structured; (b) providing a coating composition, which comprises a solvent component, preferably comprising ethyl acetate, propyl acetate, butyl acetate, and/or n-propanol, and a silicone system curable by UV radiation; (c) coating at least a part of the first surface side of the carrier film provided in step (a) using the coating composition provided in step (b); (d) evaporating at least a part of the solvent component; and (e) irradiating at least part of the first surface side of the carrier film coated in step (c) using UV radiation to cure the silicone system. 2. The method according to embodiment 1, wherein the release coating directly adjoins the carrier film. 3. The method according to embodiment 1 or 2, wherein the release film has a total layer thickness of at least 5.0 μm; preferably at least 6.0 μm, more preferably at least 7.0 μm, even more preferably at least 8.0 μm, most preferably at least 9.0 μm, and in particular at least 10 μm. 4. The method according to any one of the preceding embodiments, wherein the release film has a total thickness of at most 50 μm; preferably at most 45 μm, more preferably at most 40 μm, even more preferably at most 35 μm, most preferably at most 30 μm, and in particular at most 25 μm. 5. The method according to any one of the preceding embodiments, wherein the release film has a total thickness in the range of 5.0 μm to 50 μm; preferably in the range of 10±5.0 μm, or 12.5±5.0 μm, or 15±5.0 μm, or 17.5±5.0 μm, or 20±5.0 μm, or 22.5±5.0 μm, or 25±5.0 μm, or 27.5±5.0 μm, or 30±5.0 μm, or 32.5±5.0 μm, or 35±5.0 μm, or 37.5±5.0 μm, or 40±5.0 μm, or 42.5±5.0 μm, or 45±5.0 μm. 6. The method according to any one of the preceding embodiments, wherein die second surface side of the release film is not coated. 7. The method according to any one of the preceding embodiments, wherein the release film consists of the carrier film and the release coating. 8. The method according to any one of embodiments 1 to 6, wherein step (c) additionally comprises coating at least part of the second surface side of the carrier film provided in step (a) using the coating composition provided in step (b) or using another coating composition. 9. The method according to any one of the preceding embodiments, wherein the first surface side and possibly the second surface side are each independently coated by at least 50%; preferably at least 60%, more preferably at least 70%, even more preferably at least 80%, most preferably at least 90%, and in particular completely (100%). 10. The method according to any one of the preceding embodiments, wherein the carrier film is structured. 11. The method according to any one of the preceding embodiments, wherein the carrier film is embossed. 12. The method according to any one of the preceding embodiments, wherein the first surface side of the carrier film is not planar. 13. The method according to any one of the preceding embodiments, wherein the first surface side of the carrier film has an embossed structure on at least part of its surface. 14. The method according to any one of the preceding embodiments, wherein the first surface side and the second surface side of the carrier film each have an embossed structure on at least part of their surface. 15. The method according to embodiment 13 or 14, wherein the embossed structure has a regular pattern. 16. The method according to any one of the preceding embodiments, wherein the first surface side of the carrier film has embossed protrusions. 17. The method according to embodiment 16, wherein the embossed protrusions have an average height of at least 0.1 mm, relative to the main extension plane of the carrier film; preferably at least 0.2 mm, more preferably at least 0.3 mm, even more preferably at least 0.4 mm, most preferably at least 0.5 mm, and in particular at least 0.6 mm. 18. The method according to embodiment 16 or 17, wherein the embossed protrusions have an average height of at most 5.0 mm, relative to the main extension plane of the carrier film; preferably at most 4.5 mm, more preferably at most 4.0 mm, even more preferably at most 3.5 mm, most preferably at most 3.0 mm, and in particular at most 2.5 mm. 19. The method according to any one of embodiments 16 to 18, wherein the embossed protrusions have an average height in the range of 0.1 to 5.0 mm, relative to the main extension plane of the carrier film; preferably in the range of 0.6±0.5 mm, or 0.8±0.5 mm, or 1.0±0.5 mm, or 1.2±0.5 mm, or 1.4±0.5 mm, or, 1.6±0.5 mm, or 1.8±0.5 mm, or 2.0±0.5 mm, or 2.2±0.5 mm, or 2.4±0.5 mm, or 2.6±0.5 mm, or 2.8±0.5 mm, or 3.0±0.5 mm, or 3.2±0.5 mm, or 3.4±0.5 mm, or 3.6±0.5 mm, or 3.8±0.5 mm, or 4.0±0.5 mm, or 4.2±0.5 mm, or 4.4±0.5 mm. 20. The method according to any one of the preceding embodiments, wherein the first surface side of the carrier film has an average peak-to-valley depth R_{z} according to DIN EN ISO 4287 of t least 5.0 μm; preferably at least 7.0 μm, more preferably at least 9.0 μm, even more preferably at least 11 μm, most preferably at least 13 μm, and in particular at least 15 μm. 21. The method according to any one of the preceding embodiments, wherein the first surface side of the carrier film has an average peak-to-valley depth R_{z} according to DIN EN ISO 4287 of at most 100 μm; preferably at most 90 μm, more preferably at most 80 μm, even more preferably at most 70 μm, most preferably at most 60 μm, and in particular at most 50 μm. 22. The method according to any one of the preceding embodiments, wherein the first surface side of the carrier film has an average peak-to-valley depth R_{z} according to DIN EN ISO 4287 in the range of 5.0 to 100 μm; preferably in the range of 10±5.0 μm, or 12.5±5.0 μm, or 15±5.0 μm, or 17.5±5.0 μm, or 20±5.0 μm, or 22.5±5.0 μm, or 25±5.0 μm, or 27.5±5.0 μm, or 30±5.0 μm, or 32.5±5.0 μm, or 35±5.0 μm, or 37.5±5.0 μm, or 40±5.0 μm, or 42.5±5.0 μm, or 45±5.0 μm, or 47.5±5.0 μm, or 50±5.0 μm, or 52.5±5.0 μm, or 55±5.0 μm, or 57.5±5.0 μm, or 60±5.0 μm, or 62.5±5.0 μm, or 65±5.0 μm, or 67.5±5.0 μm, or 70±5.0 μm, or 72.5±5.0 μm, or 75±5.0 μm, or 77.5±5.0 μm, or 80±5.0 μm, or 82.5±5.0 μm, or 85±5.0 μm or 87.5±5.0 μm, or 90±5.0 μm, or 92.5±5.0 μm, or 95±5.0 μm. 23. The method according to any one of the preceding embodiments, wherein the carrier film is single layer. 24. The method according to any one of embodiments 1 to 22, wherein the carrier film is multilayer. 25. The method according to embodiment 24, wherein the multilayer carrier film consists of a total of two, three, four, five, six, seven, eight, or nine layers. 26. The method according to embodiment 2425, wherein the multilayer carrier film has a symmetrical layer sequence. 27. The method according to any one of embodiments 24 to 26, wherein the multilayer carrier film comprises a first outer layer, which forms the first surface side, and comprises a second outer layer, which forms the second surface side. 28. The method according to embodiment 27, wherein the multilayer carrier film additionally comprises at least one intermediate layer, wherein the at least one intermediate layer is arranged between the first outer layer and the second outer layer. 29. The method according to any one of the preceding embodiments, wherein the carrier film (i) is based on polyolefin or comprises at least one layer which is based on polyolefin; (ii) is based on a nonwoven or comprises at least one layer which is based on a nonwoven; or (iii) is based on paper or comprises at least one layer which is based on paper. 30. The method according to embodiment 29, wherein the at least one layer based on polyolefin forms the first surface side of the carrier film. 31. The method according to embodiment 29 or 30, wherein the polyolefin is selected from the group consisting of thermoplastic olefins; and/or olefin homopolymers or copolymers of α,ß-unsaturated olefins having 2 to 10 carbon atoms; preferably selected from the group consisting of polyethylene, polypropylene, polybutylene, polyisobutylene, copolymers and/or mixtures of at least two of the polymers mentioned. 32. The method according to any one of embodiments 29 to 31, wherein the carrier film is based on a polyolefin mixture, or wherein the carrier film comprises at least one layer which is based on a polyolefin mixture. 33. The method according to embodiment 32, wherein the polyolefin mixture comprises at least two polyolefins which are incompatible with one another. 34. The method according to any one of the preceding embodiments, wherein the carrier film comprises an additive or wherein the carrier film comprises at least one layer which comprises an additive, wherein the additive is selected from the group consisting of plasticizers; lubricants; emulsifiers; pigments; rheology additives; catalysts; flow control agents; optical brighteners; light stabilizers; antioxidants; clarifying agents such as substituted or unsubstituted bisbenzylidene sorbitols; flame retardants; antistatic agents; UV absorbers such as benzoxazinones; propellants; and thiosynergists such as thiodipropionic acid dilauryl esters or thiodipropionic acid distearyl esters. 35. The method according to any one of the preceding embodiments, wherein the release coating has a basis weight of at least 0.1 g/m²; preferably at least 0.15 g/m², more preferably at least 0.2 g/m², even more preferably at least 0.25 g/m², most preferably at least 0.3 g/m², and in particular at least 0.35 g/m². 36. The method according to any one of the preceding embodiments, wherein the release coating has a basis weight of at most 1.0 g/m²; preferably at most 0.9 g/m², more preferably at most 0.8 g/m², even more preferably at most 0.7 g/m², most preferably at most 0.6 g/m², and in particular at most 0.5 g/m². 37. The method according to any one of the preceding embodiments, wherein the release coating has a basis weight in the range of 0.1 g/m²o 1.0 g/m²; preferably in the range of 0.3±0.2 g/m², or 0.35±0.2 g/m², or 0.4±0.2 g/m², or 0.45±0.2 g/m², or 0.5±0.2 g/m², or 0.55±0.2 g/m², or 0.6±0.2 g/m², or 0.65±0.2 g/m², or 0.7±0.2 g/m², or 0.75±0.2 g/m², or 0.8±0.2 g/m². 38. The method according to any one of the preceding embodiments, wherein the release coating has a layer thickness of at least 1.0 μm; preferably at least 1.5 μm, more preferably at least 2.0 μm, even more preferably at least 2.5 μm, most preferably at least 3.0 μm, and in particular at least 3.5 μm. 39. The method according to any one of the preceding embodiments, wherein the release coating has a layer thickness of at most 4.0 μm; preferably at most 3.5 μm, more preferably at most 3.0 μm, even more preferably at most 2.5 μm, and in particular at most 2.0 μm. 40. The method according to any one of the preceding embodiments, wherein the release coating has a layer thickness in the range of 1.0 to 4.0 μm; preferably in the range of 1.5±0.5 μm, or 2.0±0.5 or 2.5±0.5 μm, or 3.0±0.5 μm, or 3.5±0.5 μm. 41. The method according to any one of the preceding embodiments, wherein the release coating is based on at least one cured polysiloxane, which is selected from the group consisting of addition-crosslinked, preferably metal-catalyzed addition-crosslinked, condensation-crosslinked, free-radically crosslinked, and/or cationically crosslinked polysiloxanes; preferably radically crosslinked polysiloxanes. 42. The method according to any one of the preceding embodiments, wherein the release coating is based on at least one cured polysiloxane, which is selected from the group consisting of polydialkylsiloxanes, preferably polydimethylsiloxanes; and polyalkylarylsiloxanes, preferably polymethylphenylsiloxanes. 43. The method according to any one of the preceding embodiments, wherein the silicone system curable by UV radiation is radically or cationically curable. 44. The method according to any one of the preceding embodiments, wherein the silicone system curable by UV radiation is preferably based on at least one polysiloxane curable by UV radiation, which is selected from the group consisting of addition-crosslinking, preferably metal-catalyzed addition-crosslinking, condensation-crosslinking, free-radically crosslinking, and/or cationically crosslinking polysiloxanes. 45. The method according to any one of the preceding embodiments, wherein the silicone system curable by UV radiation is preferably based on at least one polysiloxane curable by UV radiation, which is selected from the group consisting of polydialkylsiloxanes, preferably polydimethylsiloxanes; and polyalkylarylsiloxanes, preferably polymethylphenylsiloxanes. 46. The method according to any one of the preceding embodiments, wherein the content of the silicone system curable by UV radiation is at least 10 wt. %, based on the total weight of the coating composition; preferably at least 20 wt. %, more preferably at least 30 wt. %, even more preferably at least 40 wt. %, most preferably at least 50 wt. %, and in particular at least 60 wt. %. 47. The method according to any one of the preceding embodiments, wherein the content of the silicone system curable by UV radiation is at most 90 wt. %, based on the total weight of the coating composition; preferably at most 80 wt. %, more preferably at most 70 wt. %, even more preferably at most 60 wt. %, Most preferably at most 50 wt. %, and in particular at most 40 wt. %. 48. The method according to any one of the preceding embodiments, wherein the content of the silicone system curable by UV radiation is in the range of 10 to 90 wt. % based on the total weight of the coating composition; preferably in the range of 20±10 wt. %, or 25±10 wt. %, or 30±10 wt. %, or 35±10 wt. %, or 40±10 wt. %, or 45±10 wt. %, or 50±10 wt. %, or 55±10 wt. %, or 60±10 wt. %, or 65±10 wt. %, or 70±10 wt. %, or 75±10 wt. %, or 80±10 wt. %. 49. The method according to any one of the preceding embodiments, wherein the solvent component comprises or consists of one or more C₁-6 alkyl acid-C₁-6 alkyl esters. 50. The method according to any one of the preceding embodiments, wherein the solvent component comprises or consists of a solvent which has a dielectric constant of at least 2.40 F/m; preferably at least 3.00 F/m, more preferably at least 3.50 F/m, even more preferably at least 4.00 F/m, most preferably at least 4.50 F/m, and in particular at least 5.00 F/m. 51. The method according to any one of the preceding embodiments, wherein the solvent component comprises or consists of a solvent which has a dielectric constant of at most 16.00 F/m; preferably at most 14.40 F/m, more preferably at most 12.40 F/m, even more preferably at most 10.40 F/m, most preferably at most 8.40 F/m, and in particular at most 6.40 F/m. 52. The method according to any one of the preceding embodiments, wherein the solvent component comprises or consists of a solvent which has a dielectric constant in the range of 2.40 F/m to 16.00 F/m aufweist; preferably in the range of 4.50±2.00 F/m, or 5.00±2.00 F/m, or 5.50±2.00 F/m, or 6.00±2.00 F/m, or 6.50±2.00 F/m, or 7.00±2.00 F/m, or 7.50±2.00 F/m, or 8.00±2.00 F/m, or 8.50±2.00 F/m, or 9.00±2.00 F/m, or 9.50±2.00 F/m, or 10.00±2.00 F/m, or 10.50±2.00 F/m, or 11.00±2.00 F/m, or 11.50±2.00 F/m, or 12.00±2.00 F/m, or 12.50±2.00 F/m, or 13.00±2.00 F/m, or 13.50±2.00 F/m, or 14.00±2.00 F/m. 53. The method according to any one of the preceding embodiments, wherein the solvent component comprises or consists of a solvent which has a boiling point of at least 70° C.; preferably at least 80° C., more preferably at least 90° C., even more preferably at least 100° C., most preferably at least 110° C., and in particular at least 120° C. 54. The method according to any one of the preceding embodiments, wherein the solvent component comprises or consists of a solvent which has a boiling point of at most 135° C.; preferably at most 125° C., more preferably at most 115° C., even more preferably at most 105° C., most preferably at most 95° C., and in particular at most 85° C. 55. The method according to any one of the preceding embodiments, wherein the solvent component comprises or consists of a solvent which has a boiling point of in the range of 70° C. to 135° C.; preferably in the range of 80±10° C., or 85±10° C., or 90±10° C., or 95±10° C., or 100±10° C., or 105±10° C., or 110±10° C., or 115±10° C., or 120±10° C., or 125±10° C. 56. The method according to any one of the preceding embodiments, wherein the solvent component comprises or consists of a solvent which has a dipole moment of at least 1.75 D; preferably at least 1.77 D, more preferably at least 1.79 D, even more preferably at least 1.81 D, most preferably at least 1.83 D, and in particular at least 1.85 D. 57. The method according to any one of the preceding embodiments, wherein the solvent component comprises or consists of a solvent which has a dipole moment of at most 1.90 D; preferably at most 1.88 D, more preferably at most 1.86 D, even more preferably at most 1.84 D, most preferably at most 1.82 D, and in particular at most 1.80 D. 58. The method according to any one of the preceding embodiments, wherein d the solvent component comprises or consists of a solvent which has a dipole moment in the range of 1.75 D to 1.90 D; preferably in the range of 1.75 D to 1.90 D; preferably in the range of 1.77±0.02 D, or 1.78±0.02 D, or 1.79±0.02 D, or 1.80±0.02 D, or 1.81±0.05 D, or 1.82±0.02 D, or 1.83±0.05 D, or 1.84±0.02 D, or 1.85±0.02 D, or 1.86±0.02 D, or 1.87±0.02 D, or 1.88±0.02 D. 59. The method according to any one of the preceding embodiments, wherein the solvent component comprises or consists of a solvent which has an evaporation number of at least 2.9; preferably at least 4.0, more preferably at least 5.0, even more preferably at least 6.0, most preferably at least 7.0, and in particular at least 8.0. 60. The method according to any one of the preceding embodiments, wherein the solvent component comprises or consists of a solvent which has an evaporation number of at most 12; preferably at most 12, more preferably at most 10, even more preferably at most 9.0, most preferably at most 8.0, and in particular at most 7.0. 61. The method according to any one of the preceding embodiments, wherein the solvent component comprises or consists of a solvent which has an evaporation number in the range of 2.9 to 11; preferably in the range of 4.0±1.0, or 4.5±1.0, or 5.0±1.0, or 5.5±1.0, or 6.0±1.0, or 6.5±1.0, or 7.0±1.0, or 7.5±1.0, or 8.0±1.0, or 8.5±1.0, or 9.0±1.0, or 9.5±1.0, or 10±1.0, or 10.5±1.0 or 11±1.0. 62. The method according to any one of the preceding embodiments, wherein the solvent is selected from the group consisting of ethyl acetate, propyl acetate, butyl acetate, and the mixtures thereof 63. The method according to embodiment 62, wherein the solvent component comprises or consists of ethyl acetate. 64. The method according to embodiment 62, wherein the solvent component comprises or consists of propyl acetate; preferably n-propyl acetate, iso-propyl acetate, or the mixture thereof 65. The method according to embodiment 62, wherein the solvent component comprises or consists of butyl acetate, preferably n-butyl acetate, iso-butyl acetate, sec-butyl acetate, tert-butyl acetate, or any mixtures thereof 66. The method according to any one of the preceding embodiments, wherein the contents of the solvent component is at least 10 wt. %, based on the total weight of the coating composition; preferably at least 20 wt. %, more preferably at least 30 wt. %, even more preferably at least 40 wt. %, most preferably at least 50 wt. %, and in particular at least 60 wt. %. 67. The method according to any one of the preceding embodiments, wherein the contents of the solvent component is at most 90 wt. %, based on the total weight of the coating composition; preferably at most 80 wt. %, more preferably at most 70 wt. %, even more preferably at most 60 wt. %, most preferably at most 50 wt. %, and in particular at most 40 wt. %. 68. The method according to any one of the preceding embodiments, wherein the contents of the solvent component is in the range of 10 to 90 wt. %, based on the total weight of the coating composition; preferably in the range of 20±10 wt. %, or 25±10 wt. %, or 30±10 wt. %, or 35±10 wt. %, or 40±10 wt. %, or 45±10 wt. %, o-der 50±10 wt. %, or 55±10 wt. %, or 60±10 wt. %, or 65±10 wt. %, or 70±10 wt. %, or 75±10 wt. %, or 80±10 wt. %. 69. The method according to any one of the preceding embodiments, wherein the coating composition has a viscosity of at least 1.0 mm²/s; preferably at least 1.5 mm²/s, more preferably at least 2.0 mm²/s, even more preferably at least 2.5 mm²/s, most preferably at least 3.0 mm²/s, and in particular at least 3.5 mm²/s. 70. The method according to any one of the preceding embodiments, wherein the coating composition has a viscosity of at most 100 mm²/s; preferably at most 90 mm²/s, more preferably at most 80 mm²/s, even more preferably at most 70 mm²/s, most preferably 60 mm²/s, and in particular at most 50 mm²/s. 71. The method according to any one of the preceding embodiments, wherein the coating composition has a viscosity in the range of 1.0 to 100 mm²/s; preferably in the range of 15±10 mm²/s, or 20±10 mm²/s, or 25±10 mm²/s, or 30±10 mm²/s, or 35±10 mm²/s, or 40±10 mm²/s, or 45±10 mm²/s, or 50±10 mm²/s, or 55±10 mm²/s, or 60±10 mm²/s, or 65±10 mm²/s, or 70±10 mm²/s, or 75±10 mm²/s, or 80±10 mm²/s, or 85±10 mm²/s, or 90±10 mm²/s. 72. The method according to any one of the preceding embodiments, wherein the viscosity of the coating composition is determined using a measuring cup according to DIN EN ISO 2431. 73. The method according to embodiment 74, wherein a measuring cup having an outlet opening of 6 mm is used; preferably of 5 mm, more preferably of 4 mm, and particularly preferably of 3 mm. 74. The method according to any one of the preceding embodiments, wherein the coating composition contains a catalyst which catalyzes the curing of the polysiloxane curable by UV radiation. 75. The method according to embodiment 76, wherein the catalyst is selected from the group consisting of α-hydroxy, α-alkoxy or α-amino aryl ketones, acylphosphine oxides, aliphatic azo compounds, or onium compounds. 76. The method according to any one of the preceding embodiments, wherein step (c) comprises cooling the coating composition in the system. 77. The method according to any one of the preceding embodiments, wherein the coating in step (c) takes place at a temperature of at least 5.0° C.; preferably at least 7.0° C., more preferably at least 9.0° C., even more preferably at least 11° C., most preferably at least 13° C., and in particular at least 15° C. 78. The method according to any one of the preceding embodiments, wherein the coating in step (c) takes place at a temperature of at most 20° C.; preferably at most 18° C., more preferably at most 16° C., even more preferably at most 14° C., most preferably at most 12° C., and in particular at most 10° C. 79. The method according to any one of the preceding embodiments, wherein the coating in step (c) takes place at a temperature in the range of 5.0° C. to 20° C.; preferably in the range of 6.0±2.0° C., or 7.0±2.0° C., or 8.0±2.0° C., or 9.0±2.0° C., or 10±2.0° C., or 11±2.0° C., or 12±2.0° C., or 13±2.0° C., or 14±2.0° C., or 15±2.0° C., or 16±2.0° C., or 17±2.0° C., or 18±2.0° C. 80. The method according to any one of the preceding embodiments, wherein step (c) comprises applying the coating composition to at least part of the first surface side of the carrier film using a flexographic printing method. 81. The method according to any one of the preceding embodiments, wherein step (c) comprises applying the coating composition to at least a part of the first surface side of the carrier film using an anilox roller. 82. The method according to any one of the preceding embodiments, wherein step (c) comprises coating at least 50% of the first surface side; preferably at least 60%, more preferably at least 70%, even more preferably at least 80%, most preferably at least 90%, and in particular completely (100%). 83. The method according to any one of the preceding embodiments, wherein the evaporation of the solvent component in step (d) takes place at a temperature of at least 30° C.; preferably at least 40° C., more preferably at least 50° C., even more preferably at least 60° C., most preferably at least 70° C., and in particular at least 80° C. 84. The method according to any one of the preceding embodiments, wherein the evaporation of the solvent component in step (d) takes place at a temperature of at most 180° C.; preferably at most 170° C., more preferably at most 160° C., even more preferably at most 150° C., most preferably at most 140° C., and in particular at most 130° C. 85. The method according to any one of the preceding embodiments, wherein the evaporation of the solvent component in step (d) takes place at a temperature in a range of 30° C. to 180° C.; preferably in the range of 50±20° C., or 60±20° C., or 70±20° C., or 80±20° C., or 90±20° C., or 100±20° C., or 110±20° C., or 120±20° C., or 130±20° C., or 140±20° C., or 150±20° C., or 160±20° C. 86. The method according to any one of the preceding embodiments, wherein the evaporation of the solvent component in step (d) takes place at a pressure of at least 100 mbar; preferably at least 150 mbar, more preferably at least 200 mbar, even more preferably at least 250 mbar, most preferably at least 300 mbar, and in particular at least 350 mbar. 87. The method according to any one of the preceding embodiments, wherein the evaporation of the solvent component in step (d) takes place at a pressure of at most 900 mbar; preferably at most 850 mbar, more preferably at most 800 mbar, even more preferably at most 750 mbar, most preferably at most 700 mbar, and in particular at most 650 mbar. 88. The method according to any one of the preceding embodiments, wherein the evaporation of the solvent component in step (d) takes place at a pressure in the range of 100 mbar to 900 mbar; preferably in the range of 150±50 mbar, or 200±50 mbar, or 250±50 mbar, or 300±50 mbar, or 350±50 mbar, or 400±50 mbar, or 450±50 mbar, or 500±50 mbar, or 550±50 mbar, or 600±50 mbar, or 650±50 mbar, or 700±50 mbar, or 750±50 mbar, or 800±50 mbar, or 850±50 mbar. 89. The method according to any one of the preceding embodiments, wherein step (d) comprises the evaporation of the solvent component to odor neutrality. 90. The method according to embodiment 89, wherein the evaporation of the solvent component in step (d) takes place to a residual contents of the solvent component of at most 100 ppmw; preferably at most 80 ppmw, more preferably at most 60 ppmw, even more preferably at most 40 ppmw, most preferably at most 20 ppmw, in particular completely (0 ppmw). 91.

The method according to any one of the preceding embodiments, wherein at least part of the coated first surface side of the carrier film is irradiated in step (e) at a wavelength of at least 170 nm; preferably at least 190 nm, more preferably at least 210 nm, even more preferably at least 230 nm, most preferably at least 250 nm, and in particular at least 270 nm. 92. The method according to any one of the preceding embodiments, wherein at least part of the coated first surface side of the carrier film is irradiated in step (e) at a wavelength of at most 400 nm; preferably at most 380 nm, more preferably at most 360 nm, even more preferably at most 340 nm, most preferably at most 320 nm, and in particular at most 300 nm. 93. The method according to any one of the preceding embodiments, wherein at least a part of the coated first surface side of the carrier film is irradiated in step (e) at a wavelength in the range of 170 nm to 400 nm; preferably in the range of 190±20 nm, or 200±20 nm, or 210±20 nm, or 220±20 nm, or 230±20 nm, or 240±20 nm, or 250±20 nm, or 260±20 nm, or 270±20 nm, or 280±20 nm, or 290±20 nm, or 300±20 nm, or 310±20 nm, or 320±20 nm, or 330±20 nm, or 340±20 nm, or 350±20 nm, or 360±20 nm, or 370±20 nm, or 380±20 nm. 94. The method according to any one of the preceding embodiments, wherein at least a part of the coated first surface side of the carrier film is irradiated in step (e) using an energy at least 3.0 eV; preferably at least 4.0 eV, more preferably at least 5.0 eV, even more preferably at least 6.0 eV, most preferably at least 7.0 eV, and in particular at least 8.0 eV. 95. The method according to any one of the preceding embodiments, wherein at least part of the coated first surface side of the carrier film is irradiated in step (e) using an energy of at most 12 eV; preferably at most 11 eV, more preferably at most 10 eV, even more preferably at most 9.0 eV, most preferably at most 8.0 eV, and in particular at most 7.0 eV. 96. The method according to any one of the preceding embodiments, wherein at least part of the coated first surface side of the carrier film is irradiated in step (e) using an energy in the range of 3.0 eV to 12 eV; preferably in the range of 5.0±2.0 eV, or 6.0±2.0 eV, or 7.0±2.0 eV, or 8.0±2.0 eV, or 9.0±2.0 eV, or 10±2.0 eV. 97. The method according to any one of the preceding embodiments, wherein at least part of the coated first surface side of the carrier film is irradiated in step (e) under protective gas atmosphere. 98. The method according to embodiment 97, wherein the protective gas atmosphere essentially comprises nitrogen. 99. The method according to any one of the preceding embodiments, wherein step (e) comprises irradiating at least 50% of the coated first surface side of the carrier film; preferably at least 60%, more preferably at least 70%, even more preferably at least 80%, most preferably at least 90%, and in particular (100%). 100. The method according to any one of the preceding embodiments, wherein step (a) additionally comprises the surface activation of at least the first surface side of the carrier film provided in (a). 101. The method according to embodiment 100, wherein the surface activation is performed by plasma or corona pretreatment. 102. A release film comprising—a carrier film having a first surface side and a second surface side; and—a release coating; wherein the first surface side of the carrier film is at least partially coated using the release coating; and wherein the release film is obtainable by the method according to any one of the preceding claims. 103. A use of a release film according to embodiment 102 as a detachable release and/or protective film for adhesive hygiene items.

The following examples are used explain the invention, but are not to be interpreted as restrictive:

### EXAMPLE 1

Multiple release films have been produced by coating release films using a release coating. The viscosity of the coating composition and the solvent contained in the coating composition were varied and the influence on the release force (TK) of the release films was studied. Furthermore, the scoop volume of the anilox roller used to apply the coating composition was varied.

The components of the coating composition are summarized in the following table:

| | wt. % |
|---|---|
| solvent | 65-75 |
| acrylate modified silicone copolymer | 20-30 |
| long chain acrylate silicone polymer | 1.0-2.0 |
| photoinitiator (catalyst) | 0.5-1.5 |

After storage for 20 h at 70° C. (or at 40° C. for examples 1-3) the release force (TK) of the release films was measured according to FINAT 10 at a peeling speed of 300 mm/min in comparison to a test adhesive tape TESA® 7475 (or 7476 for examples 1-3) from Beiersdorf. Three tests were carried out at the infeed and at the end of each release film.

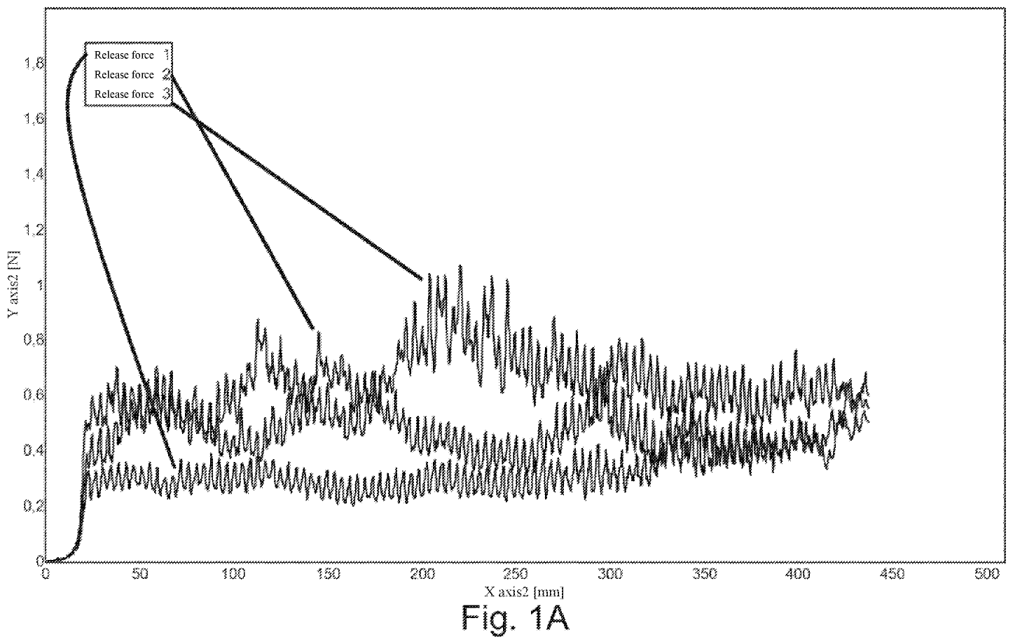

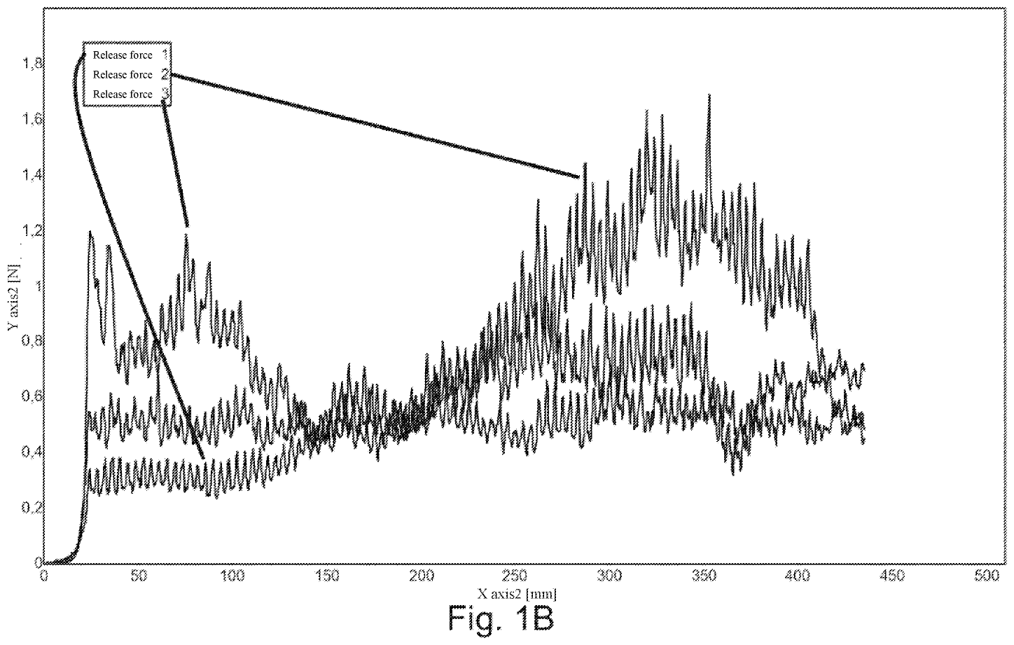

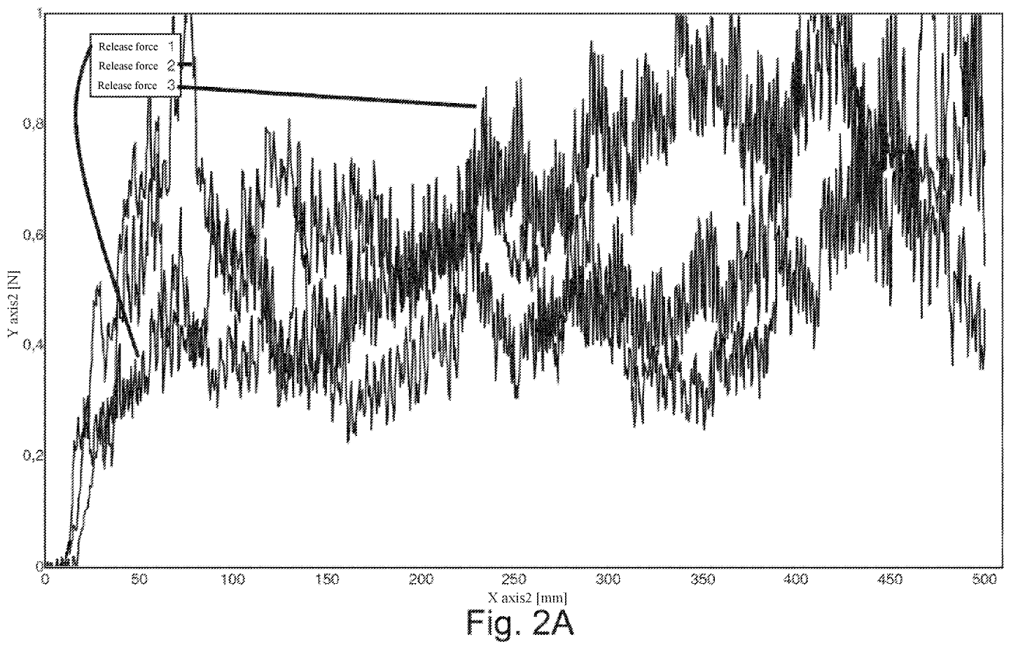

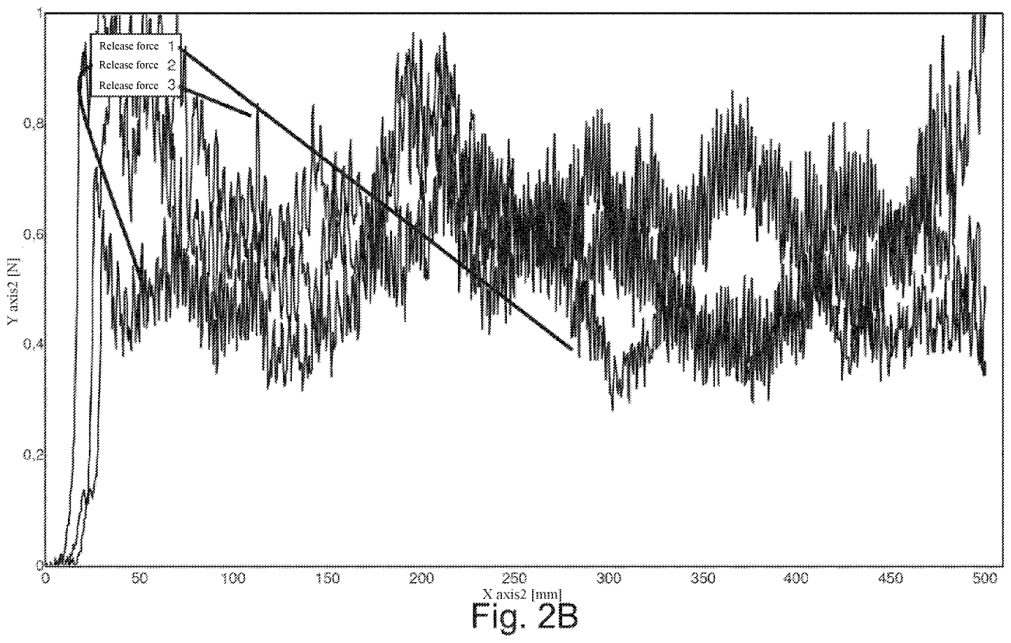

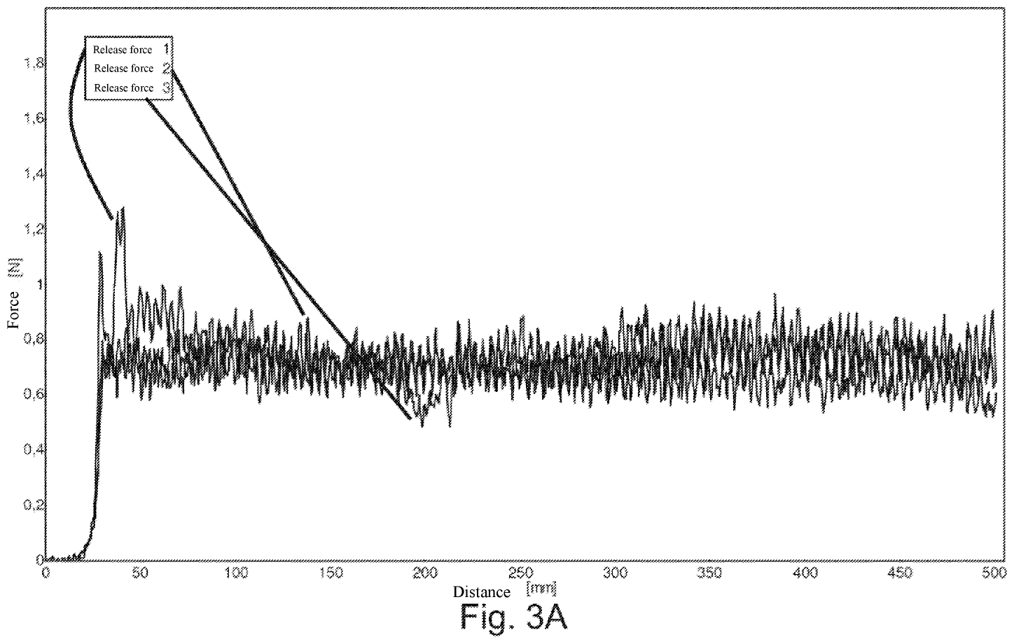

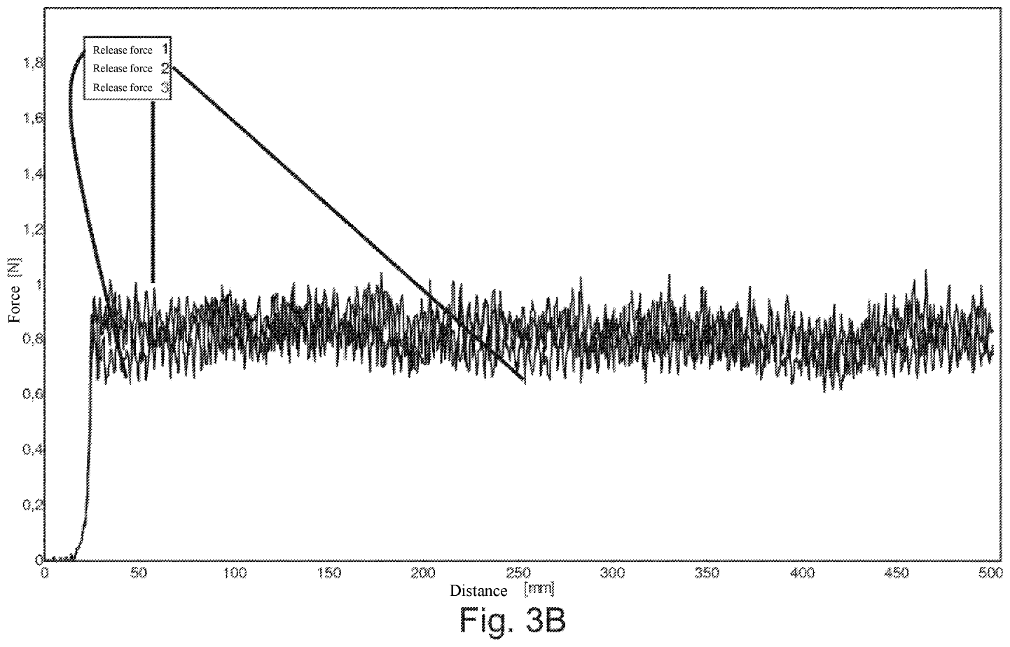

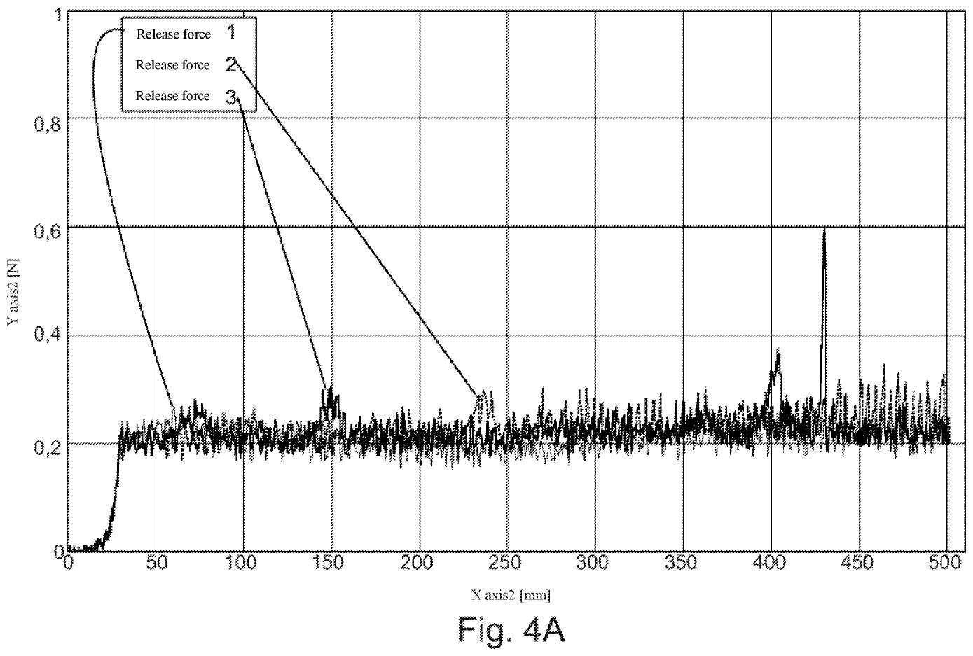

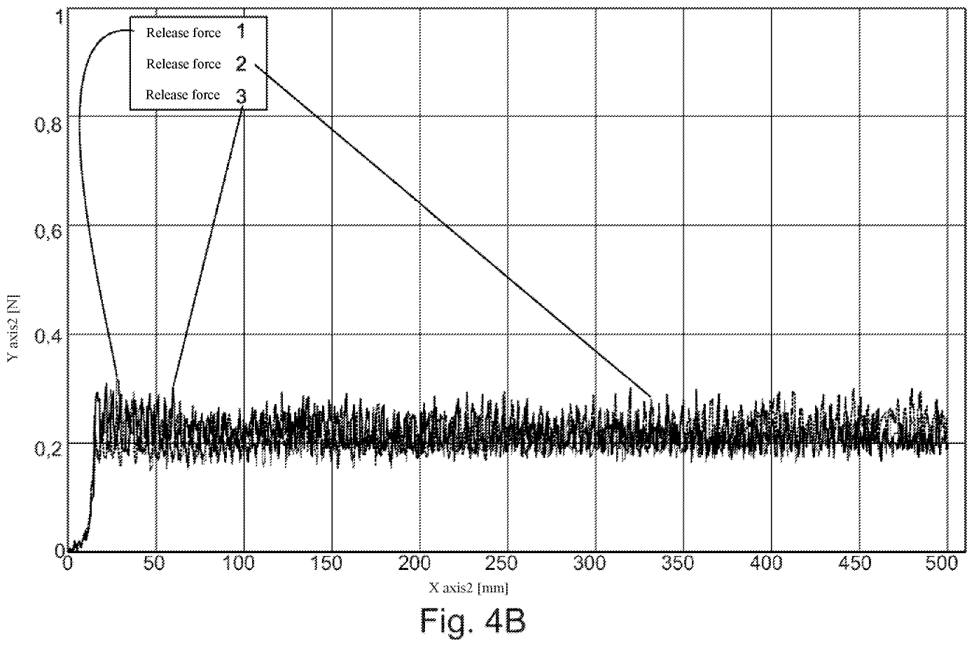

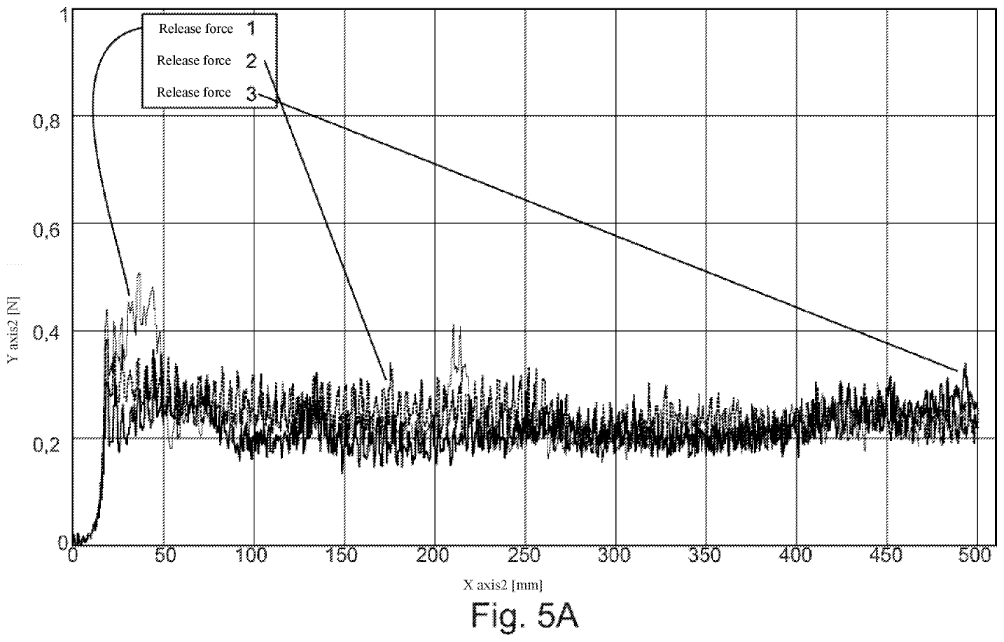

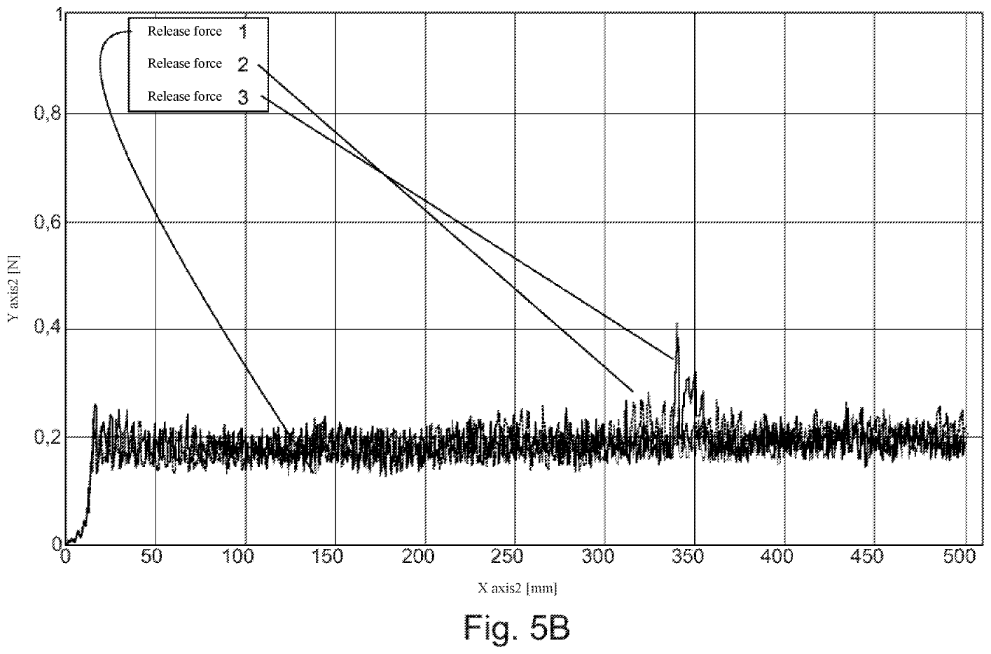

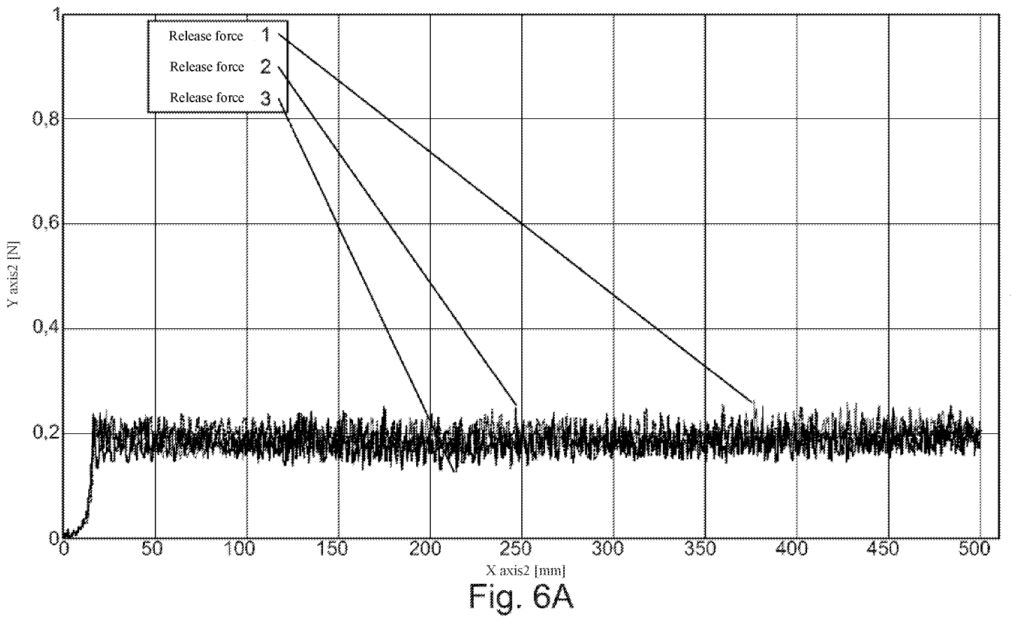

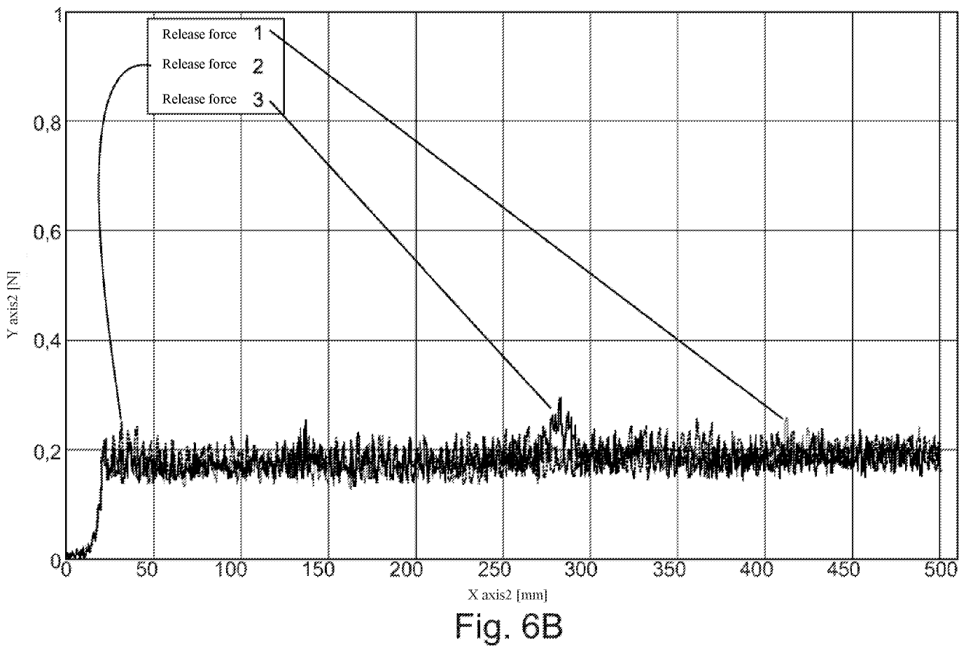

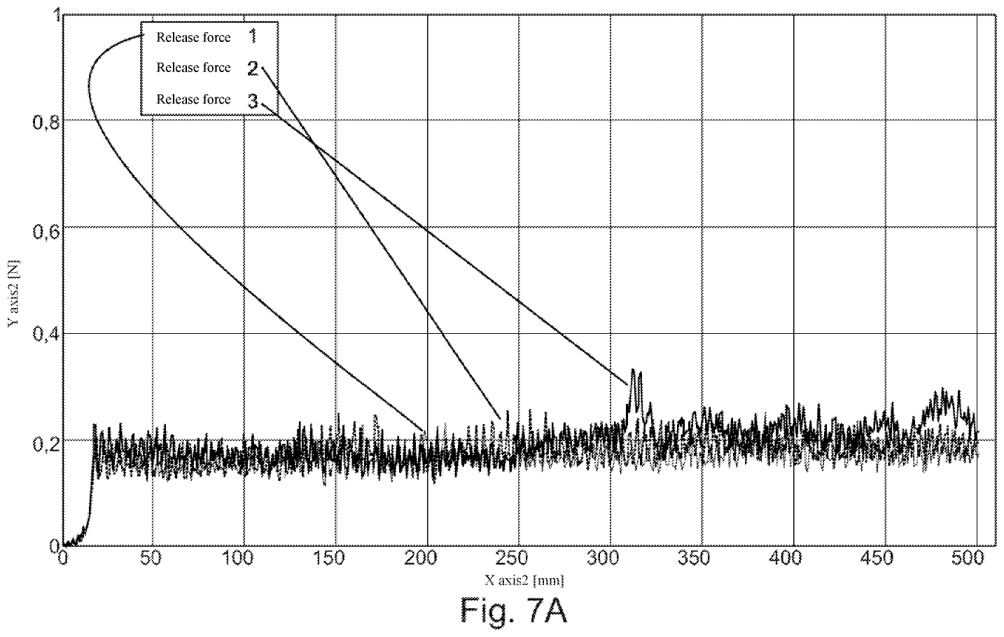

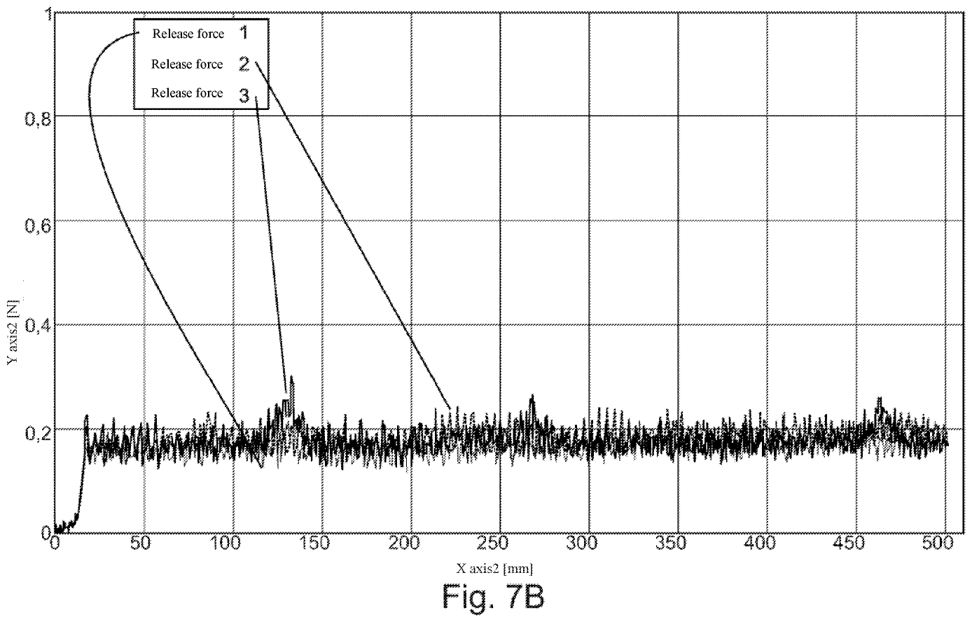

The results are shown in FIGS. 1 to 7; FIG. 1 shows the release force (TK) for example 1-1, FIG. 2 for example 1-2, FIG. 3 for example 1-3, FIG. 4 for example 1-4, FIG. 5 for example 1-5, FIG. 6 for example 1-6, and FIG. 7 for example 1-7. The results of the tests at the infeed (FIGS. 1A, 2A, 3A, 4A, 5A, 6A, and 7A) and at the end (FIGS. 1B, 2B, 3B, 4B, 5B, 6B, and 7B) of each release film are shown.

The results are summarized in the following table:

| | 1-1 | | 1-2 | | 1-3 | | 1-4 | | 1-5 | | 1-6 | | 1-7 | |
|---|---|---|---|---|---|---|---|---|---|---|---|---|---|---|
| ethyl acetate [%] | 100 | | 100 | | 100 | | 100 | | 80 | | 50 | | 100 | |
| n-propanol [%] | — | | — | | — | | — | | — | | 50 | | — | |
| ethoxypropanol [%] | — | | — | | — | | — | | 20 | | — | | — | |
| anilox roller | 5 | | 5 | | 5 | | 5 | | 5 | | 5 | | 4 | |
| [cm³/m²] | | | | | | | | | | | | | | |
| infeed/end | in | end | in | end | in | end | in | end | in | end | in | end | in | end |
| viscosity | 30 | | 28 | | 27 | | 19 | | 20.5 | 20.5 | — | 21.2 | 19.4 | 19.3 |
| (3 mm cup) [s] | | | | | | | | | | | | | | |
| basis weight [g/m²] | 0.73 | 0.55 | 0.73 | 0.69 | 0.59 | 0.57 | 0.27 | 0.255 | 0.315 | 0.345 | 0.285 | 0.3 | 0.41 | 0.43 |
| TK1 [cN/cm] | 13.5 | 18.9 | 19.3 | 23.1 | 28.3 | 32.7 | 8.3 | 8.2 | 9.0 | 7.2 | 7.7 | 7.2 | 6.7 | 6.6 |
| TK1max [cN/cm] | 27.7 | 29.0 | 58.2 | 45.4 | 51.2 | 41.9 | 11.9 | 11.6 | 19.8 | 10.9 | 11.0 | 11.0 | 10.1 | 9.9 |
| TK2 [cN/cm] | 22.6 | 31.0 | 23.5 | 23.7 | 29.5 | 32.6 | 9.1 | 8.8 | 9.5 | 7.6 | 7.6 | 7.4 | 7.2 | 7.2 |
| TK2max [cN/cm] | 35.2 | 67.4 | 53.4 | 44.7 | 38.8 | 41.6 | 14.1 | 12.4 | 15.0 | 11.7 | 10.4 | 10.9 | 10.7 | 10.1 |
| TK3 [cN/cm] | 22.5 | 27.2 | 28.2 | 23.0 | 28.5 | 33.0 | 8.9 | 8.6 | 8.7 | 7.5 | 7.3 | 7.2 | 7.9 | 7.0 |
| TK3max [cN/cm] | 43.5 | 47.8 | 44.2 | 40.7 | 37.5 | 42.9 | 24.0 | 13.0 | 14.3 | 16.5 | 10.1 | 12.2 | 14.0 | 11.8 |
| Ø TK [cN/cm] | 19.5 | 25.7 | 23.7 | 23.3 | 28.8 | 32.8 | 8.8 | 8.5 | 9.1 | 7.4 | 7.5 | 7.3 | 7.3 | 6.9 |
| σ² TK [cN²/cm²] | 18.20 | 25.53 | 13.22 | 0.10 | 0.28 | 0.03 | 0.12 | 0.06 | 0.11 | 0.03 | 0.03 | 0.01 | 0.24 | 0.06 |

| | | | | | | | |
|---|---|---|---|---|---|---|---|
| Ø TK total [cN/cm] | 22.62 | 23.47 | 30.77 | 8.65 | 8.25 | 7.40 | 7.10 |
| σ² TK total | 31.37 | 6.70 | 4.15 | 0.10 | 0.74 | 0.04 | 0.18 |
| [cN²/cm²] | | | | | | | |

As the data in the table above shows, the viscosity of the coating composition in particular has a significant influence on the release force (TK). At a lower viscosity (shorter flow time in the 3 mm cup) and a comparable basis weight, a significantly lower release force is achieved. In addition, a more even distribution of the release force along the measuring section is achieved at a lower viscosity, which is expressed, among other things, by the smaller measured values for TK1max, TK2max, and TK3max, but also in particular by the variance (σ²). The release forces determined in the individual measurements for TK1, TK2, and TK3 deviate significantly more from one another at higher viscosities than at lower viscosities (e.g., 1-1:13.5, 22.6, and 22.5 (σ² 18.20) vs. 1-6:7.7, 7.6, and 7.3 (σ² 0.03)).

1. A release film comprising
(i) a carrier film comprising
optionally a first sealing layer (a);
a layer (b), which is based on polyolefin, wherein the polyolefin is selected from the group consisting of olefin homopolymers or copolymers of α,ß-unsaturated olefins having 2 to 10 carbon atoms; and
optionally a second sealing layer (c); and
(ii) a release coating, which has a basis weight of at most 0.7 g/m²;
wherein the carrier film has a first surface side and a second surface side;
wherein the first surface side of the carrier film is at least partially coated using the release coating; and
wherein the release film has a total layer thickness of at most 25 μm.

2. The release film according to claim 1, wherein the polyolefin is selected from the group consisting of polyethylene, polypropylene, polybutylene, polyisobutylene, polyhexene, polyoctene, copolymers and/or mixtures of at least two of the polymers mentioned.

3. The release film according to claim 1 or 2, wherein the olefin homopolymer or copolymer is an ethylene homopolymer or an ethylene copolymer.

4. The release film according to claim 3, wherein the ethylene homopolymer or copolymer is selected from the group consisting of low density polyethylene (LDPE), linear low density polyethylene (LLDPE), medium density polyethylene (MDPE), and high density polyethylene (HDPE).

5. The release film according to any one of the preceding claims, wherein the polyolefin comprises a mixture of an ethylene homopolymer or copolymer and a propylene homopolymer or copolymer.

6. The release film according to any one of the preceding claims, wherein the polyolefin comprises a mixture of
51 to 85 wt. % of an ethylene homopolymer or copolymer having a density in the range of 0.91 to 0.97 g/cm³; and
15 to 49 wt. % of a propylene homopolymer or copolymer;
each based on the total weight of the mixture.

7. The release film according to any one of the preceding claims, wherein release coating has a basis weight of at most 0.65 g/m²; preferably at most 0.60 g/m², more preferably at most 0.55 g/m², even more preferably at most 0.50 g/m², most preferably at most 0.45 g/m², and in particular at most 0.40 g/m²; preferably at most 0.35 g/m², more preferably at most 0.30 g/m², even more preferably at most 0.25 g/m², most preferably at most 0.20 g/m².

8. The release film according to any one of the preceding claims, which has a total layer thickness of at least 10 μm.

9. The release film according to any one of the preceding claims, wherein the optionally provided first sealing layer (a) and/or the optionally provided second sealing layer (c) are each independently based on
polyolefins, wherein the polyolefin is selected from the group consisting of olefin homopolymers or copolymers of α,ß-unsaturated olefins having 2 to 10 carbon atoms; and
an ethylene-vinyl acetate copolymer.

10. The release film according to any one of the preceding claims, wherein the optionally provided first sealing layer (a) and/or the optionally provided second sealing layer (c) are each independently based on an ethylene-vinyl acetate polymer.

11. The release film according to any one of the preceding claims, wherein the optionally provided first sealing layer (a) and/or the optionally provided second sealing layer (c) are each independently based on polyolefin, wherein the polyolefin is selected from the group consisting of olefin homopolymers or copolymers of α,β-unsaturated olefins having 2 to 10 carbon atoms.

12. The release film according to claim 11, wherein the polyolefin is selected from the group consisting of polyethylene, polypropylene, polybutylene, polyisobutylene, polyhexene, polyoctene, copolymers and/or mixtures of at least two of the polymers mentioned.

13. The release film according to claim 11 or 12, wherein the olefin homopolymer or copolymer is an ethylene homopolymer or an ethylene copolymer.

14. The release film according to claim 13, wherein the ethylene homopolymer or copolymer is selected from the group consisting of low density polyethylene (LDPE), linear low density polyethylene (LLDPE), medium density polyethylene (MDPE), and high density polyethylene (HDPE).

15. The release film according to any one of the preceding claims, wherein the release coating directly adjoins with the carrier film.

16. The release film according to any one of the preceding claims, which has a total layer thickness of at least 5.0 μm; preferably at least 6.0 μm, more preferably at least 7.0 μm, even more preferably at least 8.0 μm, most preferably at least 9.0 μm, and in particular at least 10 μm.

17. The release film according to any one of the preceding claims, which has a total layer thickness in the range of 5.0 μm to 50 μm; preferably in the range of 10±5.0 μm, or 12.5±5.0 μm, or 15±5.0 μm, or 17.5±5.0 μm, or 20±5.0 μm.

18. The release film according to any one of the preceding claims, wherein the second surface side of the release film is uncoated.

19. The release film according to any one of the preceding claims, which consists of the carrier film and the release coating.

20. The release film according to any one of the preceding claims, wherein the first surface side and optionally the second surface side are preferably each coated independently of one another by at least 10%; preferably at least 20%, preferably at least 30%, preferably at least 40%, preferably at least 50%, preferably at least 60%, more preferably at least 70%, even more preferably at least 80%, most preferably at least 90%, and in particular completely (100%).

21. The release film according to any one of the preceding claims, wherein the carrier film is smooth.

22. The release film according to any one of the preceding claims, wherein the carrier film is structured.

23. The release film according to any one of the preceding claims, wherein the carrier film is embossed.

24. The release film according to any one of the preceding claims, wherein the first surface side of the carrier film is non-planar.

25. The release film according to any one of the preceding claims, wherein the first surface side of the carrier liner has an embossed structure on at least part of its surface.

26. The release film according to any one of the preceding claims, wherein first surface side and the second surface side of the carrier film each have an embossed structure on at least part of their surface.

27. The release film according to claim 25 or 26, wherein the embossed structure has a regular pattern.

28. The release film according to any one of the preceding claims, wherein the first surface side of the carrier film has embossed protrusions.

29. The release film according to any one of the preceding claims, wherein the first surface side of the carrier film has an average peak-to-valley height R_{z} according to DIN EN ISO 4287 of at least 5.0 μm; preferably at least 7.0 μm, more preferably at least 9.0 μm, even more preferably at least 11 μm, most preferably at least 13 μm, and in particular at least 15 μm.

30. The release film according to any one of the preceding claims, wherein the first surface side of the carrier film preferably has an average peak-to-valley height R_{z} according to DIN EN ISO 4287 of at most 100 μm; preferably at most 90 μm, more preferably at most 80 μm, even more preferably at most 70 μm, most preferably at most 60 μm, and in particular at most 50 μm.

31. The release film according to any one of the preceding claims, wherein the first surface side of the carrier film has an average peak-to-valley height R_{z} according to DIN EN ISO 4287 in the range of 5.0 to 100 μm; preferably in the range of 10±5.0 μm, or 12.5±5.0 μm, or 15±5.0 μm, or 17.5±5.0 μm, or 20±5.0 μm, or 22.5±5.0 μm, or 25±5.0 μm, or 27.5±5.0 or 30±5.0 μm, or 32.5±5.0 μm, or 35±5.0 μm, or 37.5±5.0 μm, or 40±5.0 μm, or 42.5±5.0 μm, or 45±5.0 μm, or 47.5±5.0 μm, or 50±5.0 μm, or 52.5±5.0 μm, or 55±5.0 μm, or 57.5±5.0 μm, or 60±5.0 μm, or 62.5±5.0 μm, or 65±5.0 μm, or 67.5±5.0 μm, or 70±5.0 or 72.5±5.0 μm, or 75±5.0 μm, or 77.5±5.0 μm, or 80±5.0 μm, or 82.5±5.0 μm, or 85±5.0 μm, or 87.5±5.0 μm, or 90±5.0 μm, or 92.5±5.0 μm, or 95±5.0 μm.

32. The release film according to any one of the preceding claims, wherein the carrier film is single-layer.

33. The release film according to any one of claims 1 to 32, wherein the carrier film is multilayer.

34. The release film of claim 33, wherein the multilayer carrier film consists of a total of two, three, four, five, six, seven, eight, or nine layers; preferably two or three layers.

35. The release film of claim 33 or 34, wherein the multilayer carrier film has a symmetrical layer sequence.

36. The release film according to any one of claims 33 to 35, wherein the multilayer carrier film consists of a total of nine layers, wherein each three layers are identical.

37. The release film according to any one of the preceding claims, wherein the carrier film consists of a total of three layers:
the first sealing layer (a) forming the first surface side;
of layer (b); and
the second sealing layer (c) forming the second surface side.

38. The release film according to any one of the preceding claims, wherein layer (b) forms the first surface side of the carrier film.

39. The release film according to any one of the preceding claims, wherein layer (b) forms the second surface side of the carrier film.

40. The release film according to any one of the preceding claims, wherein the first sealing layer (a) forms the first surface side of the carrier film.

41. The release film according to any one of the preceding claims, wherein the second sealing layer (c) forms the second surface side of the carrier film.

42. The release film according to any one of the preceding claims, wherein the carrier film is based on a polyolefin blend, or wherein the carrier film comprises at least one layer which is based on a polyolefin blend.

43. The release film according to claim 42, wherein the polyolefin blend comprises at least two polyolefins which are incompatible with one another.

44. The release film according to any one of the preceding claims, wherein the carrier film comprises an additive or the carrier film comprises at least one layer which comprises an additive, wherein the additive is selected from the group consisting of fillers, such as CaCO₃, plasticizers; lubricants; emulsifiers; pigments; rheology additives; catalysts; flow control agents; optical brighteners; light stabilizers; antioxidants; clarifying agents such as substituted or unsubstituted bisbenzylidene sorbitols; flame retardants; antistatic agents; UV absorbers such as benzoxazinones; propellants; and thiosynergists such as thiodipropionic acid dilauryl esters or thiodipropionic acid distearyl esters.

45. The release film according to any one of the preceding claims, wherein the carrier film does not comprise a layer which is based on a nonwoven or comprises a nonwoven.

46. The release film according to any one of the preceding claims, wherein the carrier film does not comprise a layer which is based on paper or comprises paper.

47. The release film according to any one of the preceding claims, wherein the release coating has a basis weight of at least 0.1 g/m²; preferably at least 0.15 g/m², more preferably at least 0.2 g/m², even more preferably at least 0.25 g/m², most preferably at least 0.3 g/m², and in particular at least 0.35 g/m².

48. The release film according to any one of the preceding claims, wherein the release coating has a basis weight of at most 0.6 g/m²; preferably at most 0.5 g/m², more preferably at most 0.4 g/m², even more preferably at most 0.3 g/m², and most preferably at most 0.2 g/m².

49. The release film according to any one of the preceding claims, wherein the release coating has a basis weight in the range of 0.1 g/m² to 0.7 g/m²; preferably in the range of 0.3±0.2 g/m², or 0.35±0.2 g/m², or 0.4±0.2 g/m², or 0.45±0.2 g/m², or 0.5±0.2 g/m²; more preferably 0.4±0.2 g/m²; even more preferably 0.40±0.15 g/m², most preferably 0.4±0.1 g/m²; and in particular 0.40±0.05 g/m².

50. The release film according to any one of the preceding claims, wherein the release coating has a layer thickness of at least 0.10 μm; preferably at least 0.15 μm, more preferably at least 0.20 μm, even more preferably at least 0.25 μm, most preferably at least 0.30 μm, and in particular at least 0.35 μm.

51. The release film according to any one of the preceding claims, wherein the release coating preferably has a layer thickness of at most 4.0 μm; preferably at most 3.5 μm, more preferably at most 3.0 μm, even more preferably at most 2.5 μm, most preferably at most 2.0 μm, and in particular at most 1.0 μm.

52. The release film according to any one of the preceding claims, wherein the release coating has a layer thickness in the range of 0.10 to 4.0 μm; preferably in the range of 0.15±0.05 or 0.20±0.05 μm, or 0.25±0.05 μm, or 0.30±0.05 μm, or 0.35±0.05 μm, or 0.45±0.05 μm, or 0.50±0.05 μm, or 0.55±0.05 μm, or 0.60±0.05 μm, or 0.65±0.05 μm, or 0.70±0.05 μm, or 0.75±0.05 μm, or 0.80±0.05 μm, or 0.85±0.05 μm, or 0.90±0.05 μm, or 0.95±0.05 μm, or 1.5±0.5 μm, or 2.0±0.5 μm, or 2.5±0.5 μm, or 3.0±0.5 μm, or 3.5±0.5 μm.

53. The release film according to any one of the preceding claims, wherein the release coating is based on at least one cured polysiloxane selected from the group consisting of
addition-crosslinked, preferably metal-catalyzed addition-crosslinked, condensation-crosslinked, free-radically crosslinked, and/or cationically crosslinked polysiloxanes; preferably radically crosslinked polysiloxanes; and/or
polydialkylsiloxanes, preferably polydimethylsiloxanes; and polyalkylarylsiloxanes, preferably polymethylphenylsiloxanes;
preferably chemically crosslinked acrylate-functionalized polysiloxanes; more preferably chemically crosslinked acrylate-functionalized polydialkylsiloxanes, preferably chemically crosslinked acrylate-functionalized polydimethylsiloxanes; or chemically crosslinked acrylate-functionalized polyalkylarylsiloxanes, preferably chemically crosslinked acrylate-functionalized polymethylphenylsiloxanes.

54. The release film according to claim 53, wherein the release coating comprises at least one further cured polysiloxane; preferably an acrylate-functionalized polydialkylsiloxane; preferably a chemically crosslinked long chain acrylate-functionalized polydialkylsiloxane;

55. The release film according to any one of the preceding claims, wherein the first sealing layer (a) has a layer thickness of at least 1.0 μm; preferably at least 2.0 μm, preferably at least 3.0 μm, preferably at least 4.0 μm, preferably at least 5.0 μm, more preferably at least 6.0 μm, even more preferably at least 7.0 μm, most preferably at least 8.0 μm, and in particular at least 9.0 μm.

56. The release film according to any one of the preceding claims, wherein the first sealing layer (a) has a layer thickness of at most 10 μm; preferably at most 9.0 μm, more preferably at most 8.0 μm, even more preferably at most 7.0 μm, most preferably at most 6.0 μm, and in particular at most 5.0 μm.

57. The release film according to any one of the preceding claims, wherein the first sealing layer (a) has a layer thickness in the range of 4.0 to 10 μm; preferably of 5.0 to 9.0 μm, and more preferably of 6.0 to 8.0 μm.

58. The release film according to any one of the preceding claims, wherein layer (b) has a layer thickness of at least 5.0 μm; preferably at least 6.0 μm, more preferably at least 8.0 μm, even more preferably at least 9.0 μm, most preferably at least 12 μm, and in particular at least 16 μm.

59. The release film according to any one of the preceding claims, wherein layer (b) has a layer thickness of at most 24.9 μm; preferably at most 22 μm, more preferably at most 20 μm, even more preferably at most 18 μm, most preferably at most 16 μm, and in particular at most 14 μm.

60. The release film according to any one of the preceding claims wherein layer (b) has a layer thickness in the range of 5.0 to 24.9 μm; preferably of 6.0 to 22 μm, more preferably of 8.0 to 20 μm, even more preferably from 9.0 to 18 μm, and most preferably of 12 to 16 μm.

61. The release film according to any one of the preceding claims, wherein the second sealing layer (c) has a layer thickness of at least 4.0 μm; preferably at least 5.0 μm, more preferably at least 6.0 μm, even more preferably at least 7.0 μm, most preferably at least 8.0 μm, and in particular at least 9.0 μm.

62. The release film according to any one of the preceding claims, wherein the second sealing layer (c) has a layer thickness of at most 10 μm; preferably at most 9.0 μm, more preferably at most 8.0 μm, even more preferably at most 7.0 μm, most preferably at most 6.0 μm, and in particular at most 5.0 μm.

63. The release film according to any one of the preceding claims, wherein the second sealing layer (c) has a layer thickness in the range of 4.0 to 10 μm; preferably of 5.0 to 9.0 μm, and more preferably of 6.0 to 8.0 μm.

64. The release film according to any one of the preceding claims, wherein the machine direction tensile strength of the release film is at least 6.5 N/cm, preferably determined according to DIN EN ISO 527-3.

65. The release film according to any one of the preceding claims, wherein the average release force of the release film
Is at least 2.0 cN/cm; preferably at least 4.0 cN/cm, more preferably at least 6.0 cN/cm, even more preferably at least 8.0 cN/cm, most preferably at least 10 cN/cm, and in particular at least 12 cN/cm;
Is at most 30 cN/cm; preferably at most 25 cN/cm, more preferably at most 20 cN/cm, even more preferably at most 15 cN/cm, most preferably at most 10 cN/cm, and in particular at most 8.0 cN/cm; and/or
Is in the range of 2.0 to 30 cN/cm; preferably in the range of 6.0±4.0 cN/cm, or 10±8.0 cN/cm, or 10±4.0 cN/cm, or 14±12 cN/cm, or 14±8.0 cN/cm, or 14±4.0 cN/cm, or 18±12 cN/cm, or 18±8.0 cN/cm, or 18±4.0 cN/cm, or 22±8.0 cN/cm, or 22±4.0 cN/cm, or 26±4.0 cN/cm;
preferably determined according to FINAT 10.

66. The release film according to any one of the preceding claims, wherein the difference between the maximum release force of the release film and the average release force of the release film is at most 20 cN/cm; preferably at most 15 cN/cm, more preferably at most 12.5 cN/cm, even more preferably at most 10 cN/cm, most preferably at most 7.5 cN/cm, and in particular at most 5.0 cN/cm; preferably determined according to FINAT 10.

67. The release film according to any one of the preceding claims, wherein the release force of the release film along the measuring section has a variance of at most 6.0 cN²/cm²; preferably at most 3.0 cN²/cm², more preferably at most 1.5 cN²/cm², even more preferably at most 0.8 cN²/cm², most preferably at most 0.4 cN²/cm², and in particular at most 0.2 cN²/cm²; preferably determined according to FINAT 10.

68. The release film according to any one of the preceding claims, wherein the release force of the release film over multiple measurements has a variance of at most 6.0 cN²/cm²; preferably at most 3.0 cN²/cm², more preferably at most 1.5 cN²/cm², even more preferably at most 0.8 cN²/cm², most preferably at most 0.4 cN²/cm², and in particular at most 0.2 cN²/cm²; preferably determined over at least two measurements, more preferably at least three measurements, even more preferably at least four measurements, most preferably at least five measurements, and in particular at least six measurements; preferably determined according to FINAT 10.

69. The release film according to any one of the preceding claims, wherein the release force of the release film over the entire surface coated using the release coating has a variance of at most 16 cN²/cm²; preferably at most 8.0 cN²/cm², more preferably at most 4.0 cN²/cm², even more preferably at most 2.0 cN²/cm², most preferably at most 1.0 cN²/cm², and in particular at most 0.5 cN²/cm²; preferably determined according to FINAT 10.

70. The release film according to any one of the preceding claims, wherein the release coating has a basis weight of at most 0.5 g/m²; preferably at most 0.45 g/m²;
wherein the release coating is preferably based on at least one cured polysiloxane; preferably selected from the group consisting of polydialkylsiloxanes, preferably polydimethylsiloxanes; and polyalkylarylsiloxanes, preferably polymethylphenylsiloxanes; preferably chemically crosslinked acrylate-functionalized polysiloxanes; more preferably chemically crosslinked acrylate-functionalized polydialkylsiloxanes, preferably chemically crosslinked acrylate-functionalized polydimethylsiloxanes; or chemically crosslinked acrylate-functionalized polyalkylarylsiloxanes, preferably chemically crosslinked acrylate-functionalized polymethylphenylsiloxanes;
wherein the release coating preferably comprises at least one other cured polysiloxane; preferably an acrylate-functionalized polydialkylsiloxane; preferably a chemically crosslinked long chain acrylate-functionalized polydialkylsiloxane;
wherein the average release force of the release film is at most 30 cN/cm; preferably at most 25 cN/cm, more preferably at most 20 cN/cm, even more preferably at most 15 cN/cm, most preferably at most 12 cN/cm, and in particular at most 10 cN/cm; preferably determined according to FINAT 10;
wherein the release force of the release film over multiple measurements has a variance of at most 6.0 cN²/cm²; preferably at most 3.0 cN²/cm², more preferably at most 1.5 cN²/cm², even more preferably at most 0.8 cN²/cm², most preferably at most 0.4 cN²/cm², and in particular at most 0.2 cN²/cm²; preferably determined over at least two measurements, more preferably at least three measurements, even more preferably at least four measurements, most preferably at least five measurements, and in particular at least six measurements; preferably determined according to FINAT 10; and
optionally, wherein the first surface side of the carrier film has an embossed structure on at least part of its surface.

71. A method for producing a release film according to any one of the preceding claims by coating a carrier film using a release coating, wherein the method comprises the following steps:
(a) providing a carrier film, wherein the carrier film has a first surface side and a second surface side;
(b) providing a coating composition which comprises a solvent component and a silicone system curable by UV radiation;
(c) coating at least a part of the first surface side of the carrier film provided in step (a) using the coating composition provided in step (b);
(d) evaporating at least a part of the solvent component; and
(e) irradiating at least a part of the first surface side of the carrier film coated in step (c) using UV radiation to cure the silicone system.

72. The method according to claim 71, wherein step (c) additionally comprises coating at least part of the second surface side of the carrier film provided in step (a) using the coating composition provided in step (b) or using another coating composition.

73. The method according to claim 71 or 72, wherein the silicone system curable by UV radiation is radically or cationically curable.

74. The method according to any one of claims 71 to 73, wherein the silicone system curable by UV radiation is based on at least one polysiloxane curable by UV radiation, which is selected from the group consisting of addition-crosslinking, preferably metal-catalyzed addition-crosslinking, condensation-crosslinking, free-radically crosslinking, and/or cationically crosslinking polysiloxanes.

75. The method according to any one of claims 71 to 74, wherein the release coating is based on at least one cured polysiloxane, which is selected from the group consisting of polydialkylsiloxanes, preferably polydimethylsiloxanes; and polyalkylarylsiloxanes, preferably polymethylphenylsiloxanes; preferably chemically crosslinked acrylate-functionalized polysiloxanes; more preferably chemically crosslinked acrylate-functionalized polydialkylsiloxanes, preferably chemically crosslinked acrylate-functionalized polydimethylsiloxanes; or chemically crosslinked acrylate-functionalized polyalkylarylsiloxanes, preferably chemically crosslinked acrylate-functionalized polymethylphenylsiloxanes;

76. The method according to any one of claims 71 to 75, wherein the content of the silicone system curable by UV radiation is at least 10 wt. %, based on the total weight of the coating composition; preferably at least 20 wt. %, more preferably at least 30 wt. %, even more preferably at least 40 wt. %, most preferably at least 50 wt. %, and in particular at least 60 wt. %.

77. The method according to any one of claims 71 to 76, wherein the content of the silicone system curable by UV radiation is at most 90 wt. %, based on the total weight of the coating composition; preferably at most 80 wt. %, more preferably at most 70 wt. %, more preferably at most 60 wt. %, most preferably at most 50 wt. %, and in particular at most 40 wt. %.

78. The method according to any one of claims 71 to 77, wherein the content of the silicone system curable by UV radiation is in the range of 10 to 90% wt. %, based on the total weight of the coating composition; preferably in the range of 20±10 wt. %, or 25±10 wt. %, or 30±10 30 wt. %, or 35±10 wt. %, or 40±10 wt. %, or 45±10 wt. %, or 50±10 wt. %, or 55±10 wt. %, or 60±10 wt. %, or 65±10 wt. %, or 70±10 wt. %, or 75±10 wt. %, or 80±10 wt. %.

79. The method according to any one of claims 71 to 78, wherein the solvent component comprises or consists of one or more C₁₋₆alkyl acid C₁₋₆alkyl esters.

80. The method according to any one of claims 71 to 79, wherein the solvent component comprises or consists of one or more C₁₋₆alkyl alcohols.

81. The method according to any one of claims 71 to 80, wherein the solvent component comprises or consists of a solvent which has a dielectric constant of at least 2.40 F/m having; preferably at least 3.00 F/m, more preferably at least 3.50 F/m, even more preferably at least 4.00 F/m, most preferably at least 4.50 F/m, and in particular at least 5.00 F/m.

82. The method according to any one of claims 71 to 81, wherein the solvent component preferably comprises or consists of a solvent which has a dielectric constant of at most 16.00 F/m having; preferably at most 14.40 F/m, more preferably at most 12.40 F/m, even more preferably at most 10.40 F/m, most preferably at most 8.40 F/m, and in particular at most 6.40 F/m.

83. The method according to any one of claims 71 to 82, wherein the solvent component comprises or consists of a solvent which has a dielectric constant in the range of 2.40 F/m to 16.00 F/m; preferably in the range of 4.50±2.00 F/m, or 5.00±2.00 F/m, or 5.50±2.00 F/m, or 6.00±2.00 F/m, or 6.50±2.00 F/m, or 7.00±2.00 F/m, or 7.50±2.00 F/m, or 8.00±2.00 F/m, or 8.50±2.00 F/m, or 9.00±2.00 F/m, or 9.50±2.00 F/m, or 10.00±2.00 F/m, or 10.50±2.00 F/m, or 11.00±2.00 F/m, or 11.50±2.00 F/m, or 12.00±2.00 F/m, or 12.50±2.00 F/m, or 13.00±2.00 F/m, or 13.50±2.00 F/m, or 14.00±2.00 F/m.

84. The method according to any one of claims 71 to 83, wherein the solvent component comprises or consists of a solvent which has a boiling point of at least 70° C.; preferably at least 80° C., more preferably at least 90° C., even more preferably at least 100° C., most preferably at least 110° C., and in particular at least 120° C.

85. The method according to any one of claims 71 to 84, wherein the solvent component comprises or consists of a solvent which has a boiling point of at most 135° C.; preferably at most 125° C., more preferably at most 115° C., even more preferably at most 105° C., most preferably at most 95° C., and in particular at most 85° C.

86. The method according to any one of claims 71 to 85, wherein the solvent component comprises or consists of a solvent which has a boiling point in the range of 70° C. to 135° C.; preferably in the range of 80±10° C., or 85±10° C., or 90±10° C., or 95±10° C., or 100±10° C., or 105±10° C., or 110±10° C., or 115±10° C., or 120±10° C., or 125±10° C.

87. The method according to any one of claims 71 to 86, wherein the solvent component comprises or consists of a solvent which has a dipole moment of at least 1.75 D; preferably at least 1.77 D, more preferably at least 1.79 D, even more preferably at least 1.81 D, most preferably at least 1.83 D, and in particular at least 1.85 D.

88. The method according to any one of claims 71 to 87, wherein the solvent component comprises or consists of a solvent which has a dipole moment of at most 1.90 D; preferably at most 1.88 D, more preferably at most 1.86 D, even more preferably at most 1.84 D, most preferably at most 1.82 D, and in particular at most 1.80 D.

89. The method according to any one of claims 71 to 88, wherein the solvent component preferably comprises or consists of a solvent which has a dipole moment in the range of 1.75 D to 1.90 D; preferably in the range of 1.75 D to 1.90 D; preferably in the range of 1.77±0.02 D, or 1.78±0.02 D, or 1.79±0.02 D, or 1.80±0.02 D, or 1.81±0.05 D, or 1.82±0.02 D, or 1.83±0.05 D, or 1.84±0.02 D, or 1.85±0.02 D, or 1.86±0.02 D, or 1.87±0.02 D, or 1.88±0.02 D.

90. The method according to any one of claims 71 to 89, wherein the solvent component comprises or consists of a solvent having an evaporation number of at least 2.9; preferably at least 4.0, more preferably at least 5.0, even more preferably at least 6.0, most preferably at least 7.0, and in particular at least 8.0.

91. The method according to any one of claims 71 to 90, wherein the solvent component comprises or consists of a solvent which has an evaporation number of at most 12; preferably at most 12, more preferably at most 10, even more preferably at most 9.0, most preferably at most 8.0, and in particular at most 7.0.

92. The method according to any one of claims 71 to 91, wherein the solvent component comprises or consists of a solvent which has an evaporation number in the range of 2.9 to 11; preferably in the range of 4.0±1.0, or 4.5±1.0, or 5.0±1.0, or 5.5±1.0, or 6.0±1.0, or 6.5±1.0, or 7.0±1.0, or 7.5±1.0, or 8.0±1.0, or 8.5±1.0, or 9.0±1.0, or 9.5±1.0, or 10±1.0, or 10.5±1.0, or 11±1.0.

93. The method according to any one of claims 71 to 92, wherein the solvent component comprises or consists of a solvent selected from the group consisting of ethyl acetate, propyl acetate, butyl acetate, and mixtures thereof.

94. The method according to claim 93, wherein the solvent component comprises or consists of ethyl acetate.

95. The method according to claim 93, wherein the solvent component comprises or consists of propyl acetate; preferably n-propyl acetate, isopropyl acetate or a mixture thereof.

96. The method according to claim 93, wherein the solvent component preferably comprises or consists of butyl acetate; preferably n-butyl acetate, isobutyl acetate, sec-butyl acetate, tertbutyl acetate, or any mixtures thereof.

97. The method according to any one of claims 71 to 93, wherein the solvent component comprises or consists of a solvent selected from the group consisting of methanol, ethanol, propanol, butanol, ethoxypropanol, and mixtures thereof.

98. The method according to claim 97, wherein the solvent component comprises or consists of propanol; preferably n-propanol, isopropanol, or mixtures thereof.

99. The method according to any one of claims 71 to 98, wherein the solvent component comprises or consists of at least two solvents.

100. The method according to claim 99, wherein the at least two solvents of the solvent component are in a ratio in the range of 5:1 to 1:1; preferably 4:1 to 1:1, preferably 3:1 to 1:1, even more preferably 2:1 to 1:1, and in particular in a ratio of 1:1.

101. The method according to any one of claims 71 to 100, wherein the solvent component comprises or consists of one or more C₁-6alkyl acid C₁-6alkyl esters and one or more C₁-6alkyl alcohols.

102. The method according to any one of claims 71 to 101, wherein the solvent component comprises or consists of at least two solvents which are selected from the group consisting of ethyl acetate, propyl acetate, butyl acetate, methanol, ethanol, propanol, butanol, ethoxypropanol, and mixtures thereof.

103. The method according to claim 102, wherein the solvent component comprises or consists of ethyl acetate and propanol; preferably n-propanol, isopropanol or a mixture thereof particularly preferably n-propanol.

104. The method according to any one of claims 71 to 103, wherein the content of the solvent component is at least 10 wt. %, based on the total weight of the coating composition; preferably at least 20 wt. %, more preferably at least 30 wt. %, even more preferably at least 40 wt. %, most preferably at least 50 wt. %, and in particular at least 60 wt. %.

105. The method according to any one of claims 71 to 104, wherein the content of the solvent component is at most 90 wt. %, based on the total weight of the coating composition; preferably at most 80 wt. %, more preferably at most 70 wt. %, more preferably at most 60 wt. %, most preferably at most 50 wt. %, and in particular at most 40 wt. %.

106. The method according to any one of claims 71 to 105, wherein the content of the solvent component is in the range of 10 to 90% wt. %, based on the total weight of the coating composition; preferably in the range of 20±10 wt. %, or 25±10 wt. %, or 30±10 wt. %, or 35±10 wt. %, or 40±10 wt. %, or 45±10 wt. %, or 50±10 wt. %, or 55±10 wt. %, or 60±10 wt. %, or 65±10 wt. %, or 70±10 wt. %, or 75±10 wt. %, or 80±10 wt. %.

107. The method according to any one of claims 71 to 106, wherein the coating composition has a viscosity of
at least 1.0 mm²/s; preferably at least 1.5 mm²/s, more preferably at least 2.0 mm²/s, even more preferably at least 2.5 mm²/s, most preferably at least 3.0 mm²/s, and in particular at least 3.5 mm²/s; and/or
at most 100 mm²/s; preferably at most 90 mm²/s, more preferably at most 80 mm²/s, even more preferably at most 70 mm²/s, most preferably 60 mm²/s, and in particular at most 50 mm²/s.

108. The method according to any one of claims 71 to 107, wherein the coating composition has a viscosity
of at most 20 mm²/s; preferably at most 19 mm²/s, more preferably at most 18 mm²/s, even more preferably at most 17 mm²/s, most preferably 16 mm²/s, and in particular at most 15 mm²/s; and/or
in the range of 1.0 to 100 mm 2/S; preferably in the range of 15±10 mm 2/s, or 20±10 mm 2/s, or 25±10 mm 2/s, or 30±10 mm 2/s, or 35±10 mm 2/s, or 40±10 mm 2/s, or 45±10 mm 2/s, or 50±10 mm 2/s, or 55±10 mm 2/s, or 60±10 mm 2/s, or 65±10 mm 2/s, or 70±10 mm 2/s, or 75±10 mm 2/s, or 80±10 mm 2/s, or 85±10 mm²/s, or 90±10 mm²/s.

109. The method according to any one of claims 71 to 108, wherein the coating composition has a flow time out of a measuring cup
of at least 5.0 s; preferably at least 10 s, more preferably at least 12 s, even more preferably at least 14 s, most preferably at least 16 s, and in particular at least 18 s; and/or
of at most 30 s; preferably at most 29 s, more preferably at most 28 s, even more preferably at most 27 s, most preferably at most 26 s, and in particular at most 25 s;
each preferably determined using a measuring cup having a flow opening of 3 mm; each preferably determined using a measuring cup according to DIN EN ISO 2431.

110. The method according to any one of claims 71 to 109, wherein the coating composition has a flow time out of a measuring cup
of at most 25 s; preferably at most 24 s, more preferably at most 23 s, even more preferably at most 22 s, most preferably at most 21 s, and in particular at most 20 s; and/or
in the range of 5.0 to 30 s; preferably in the range of 8.0 to 28 s; more preferably 11 to 26 s, even more preferably 14 to 24 s, most preferably 16 to 23 s, and in particular 18 to 22 s;
each preferably determined using a measuring cup having a flow opening of 3 mm; each preferably determined using a measuring cup according to DIN EN ISO 2431.

111. The method according to any one of claims 71 to 110, wherein the viscosity of the coating composition is determined using a measuring cup according to DIN EN ISO 2431.

112. The method according to claim 111, wherein a measuring cup having a flow opening of 6 mm is used; preferably 5 mm, more preferably 4 mm, and particularly preferably 3 mm.

113. The method according to any one of claims 71 to 112, wherein the coating composition contains a catalyst which catalyzes the curing of the polysiloxane curable by UV radiation.

114. The method according to claim 113, wherein the catalyst is selected from the group consisting of α-hydroxy, α-alkoxy or α-amino aryl ketones, acylphosphine oxides, aliphatic azo compounds, or onium compounds.

115. The method according to any one of claims 71 to 114, wherein step (c) comprises cooling the coating composition in the system.

116. The method according to any one of claims 71 to 115, wherein the coating in step (c) takes place at a temperature of at least 5.0° C.; preferably at least 7.0° C., more preferably at least 9.0° C., even more preferably at least 11° C., most preferably at least 13° C., and in particular at least 15° C.

117. The method according to any one of claims 71 to 116, wherein the coating in step (c) preferably takes place at a temperature of at most 20° C.; preferably at most 18° C., more preferably at most 16° C., even more preferably at most 14° C., most preferably at most 12° C., and in particular at most 10° C.

118. The method according to any one of claims 71 to 117, wherein the coating in step (c) preferably takes place at a temperature in the range of 5.0° C. to 20° C.; preferably in the range of 6.0±2.0° C., or 7.0±2.0° C., or 8.0±2.0° C., or 9.0±2.0° C., or 10±2.0° C., or 11±2.0° C., or 12±2.0° C., or 13±2.0° C., or 14±2.0° C., or 15±2.0° C., or 16±2.0° C., or 17±2.0° C., or 18±2.0° C.

119. The method according to any one of claims 71 to 118, wherein step (c) comprises applying the coating composition to at least part of the first surface side of the carrier film using a printing method, preferably a flexographic printing method.

120. The method according to any one of claims 71 to 119, wherein step (c) comprises applying the coating composition to at least part of the first surface side of the carrier film using an anilox roller.

121. The method according to any one of claims 71 to 120, wherein step (c) comprises coating at least 50% of the first surface side; preferably at least 60%, more preferably at least 70%, more preferably at least 80%, most preferably at least 90%, and in particular completely (100%).

122. The method according to any one of claims 71 to 121, wherein the evaporation of the solvent component in step (d) takes place at a temperature of at least 30° C.; preferably at least 40° C., more preferably at least 50° C., even more preferably at least 60° C., most preferably at least 70° C., and in particular at least 80° C.

123. The method according to any one of claims 71 to 122, wherein the evaporation of the solvent component in step (d) takes place at a temperature of at most 180° C.; preferably at most 170° C., more preferably at most 160° C., even more preferably at most 150° C., most preferably at most 140° C., and in particular at most 130° C.

124. The method according to any one of claims 71 to 123, wherein the evaporation of the solvent component in step (d) takes place at a temperature in a range of 30° C. to 180° C.; preferably in the range of 50±20° C., or 60±20° C., or 70±20° C., or 80±20° C., or 90±20° C., or 100±20° C., or 110±20° C., or 120±20° C., or 130±20° C., or 140±20° C., or 150±20° C., or 160±20° C.

125. The method according to any one of claims 71 to 124, wherein the evaporation of the solvent component in step (d) takes place at a pressure of at least 100 mbar; preferably at least 150 mbar, more preferably at least 200 mbar, even more preferably at least 250 mbar, most preferably at least 300 mbar, and in particular at least 350 mbar.

126. The method according to any one of claims 71 to 125, wherein the evaporation of the solvent component in step (d) takes place at a pressure of at most 900 mbar; preferably at most 850 mbar, more preferably at most 800 mbar, even more preferably at most 750 mbar, most preferably at most 700 mbar, and in particular at most 650 mbar.

127. The method according to any one of claims 71 to 126, wherein the evaporation of the solvent component in step (d) takes place at a pressure in the range of 100 mbar to 900 mbar; preferably in the range of 150±50 mbar, or 200±50 mbar, or 250±50 mbar, or 300±50 mbar, or 350±50 mbar, or 400±50 mbar, or 450±50 mbar, or 500±50 mbar, or 550±50 mbar, or 600±50 mbar, or 650±50 mbar, or 700±50 mbar, or 750±50 mbar, or 800±50 mbar, or 850±50 mbar.

128. The method according to any one of claims 71 to 127, wherein step (d) comprises evaporating the solvent component to odor neutrality.

129. The method according to claim 128, wherein the solvent component is evaporated in step (d) down to a residual content of the solvent component of at most 100 ppmw; preferably at most 80 ppmw, more preferably at most 60 ppmw, even more preferably at most 40 ppmw, most preferably at most 20 ppmw, in particular completely (0 ppmw).

130. The method according to any one of claims 71 to 129, wherein at least part of the coated first surface side of the carrier film is irradiated in step (e) at a wavelength of at least 170 nm; preferably at least 190 nm, more preferably at least 210 nm, even more preferably at least 230 nm, most preferably at least 250 nm, and in particular at least 270 nm.

131. The method according to any one of claims 71 to 130, wherein at least part of the coated first surface side of the carrier film is irradiated in step (e) at a wavelength of at most 400 nm; preferably at most 380 nm, more preferably at most 360 nm, even more preferably at most 340 nm, most preferably at most 320 nm, and in particular at most 300 nm.

132. The method according to any one of claims 71 to 131, wherein at least part of the coated first surface side of the carrier film is irradiated in step (e) at a wavelength in the range of 170 nm to 400 nm; preferably in the range of 190±20 nm, or 200±20 nm, or 210±20 nm, or 220±20 nm, or 230±20 nm, or 240±20 nm, or 250±20 nm, or 260±20 nm, or 270±20 nm, or 280±20 nm, or 290±20 nm, or 300±20 nm, or 310±20 nm, or 320±20 nm, or 330±20 nm, or 340±20 nm, or 350±20 nm, or 360±20 nm, or 370±20 nm, or 380±20 nm.

133. The method according to any one of claims 71 to 132, wherein at least part of the coated first surface side of the carrier film is irradiated in step (e) using an energy of at least 3.0 eV; preferably at least 4.0 eV, more preferably at least 5.0 eV, even more preferably at least 6.0 eV, most preferably at least 7.0 eV, and in particular at least 8.0 eV.

134. The method according to any one of claims 71 to 133, wherein at least part of the coated first surface side of the carrier film is irradiated in step (e) using an energy of at most 12 eV; preferably at most 11 eV, more preferably at most 10 eV, even more preferably at most 9.0 eV, most preferably at most 8.0 eV, and in particular at most 7.0 eV.

135. The method according to any one of claims 71 to 134, wherein at least part of the coated first surface side of the carrier film is preferably irradiated in step (e) using an energy in the range of 3.0 eV to 12 eV; preferably in the range of 5.0±2.0 eV, or 6.0±2.0 eV, or 7.0±2.0 eV, or 8.0±2.0 eV, or 9.0±2.0 eV, or 10±2.0 eV.

136. The method according to any one of claims 71 to 135, wherein at least part of the coated first surface side of the carrier film is irradiated in step (e) under a protective gas atmosphere.

137. The method according to claim 136, wherein the protective atmosphere essentially comprises nitrogen.

138. The method according to any one of claims 71 to 137, wherein step (e) comprises irradiating at least 50% of the coated first surface side; preferably at least 60%, more preferably at least 70%, more preferably at least 80%, most preferably at least 90%, and in particular completely (100%).

139. The method according to any one of claims 71 to 138, wherein step (a) additionally comprises surface activation of at least the first surface side of the carrier film provided in (a).

140. The method according to claim 139, wherein the surface activation is carried out by a pretreatment with plasma or corona.

141. A use of a release film according to any one of claims 1 to 70 as a detachable release and/or protective film for adhesive hygiene items.
